(19) United States
(12) Patent Application Publication
(10) Pub. No.: US 2014/0226081 A1
(43) Pub. Date: Aug. 14, 2014

(54) DISPLAY UNIT AND TELEVISION RECEIVING APPARATUS

(71) Applicant: Masatoshi Tomomasa, Osaka (JP)

(72) Inventor: Masatoshi Tomomasa, Osaka (JP)

(73) Assignee: SHARP KABUSHIKI KAISHA, Osaka (JP)

(21) Appl. No.: 14/342,963

(22) PCT Filed: Sep. 3, 2012
(86) PCT No.: PCT/JP2012/072336

§ 371 Date: Mar. 5, 2014

(30) Foreign Application Priority Data
Sep. 8, 2011 (JP) 2011-196312

(51) Int. Cl. G02F 1/1333; H04N 5/645

(52) U.S. Cl. CPC G02F 1/133308; H04N 5/645; G02F 2001/13332
USPC 348/794; 349/58

(57) ABSTRACT

A liquid crystal display device 10 according to the present invention includes: LEDs 17; a liquid crystal panel 11 capable of displaying images through light from the LEDs 17; a light guide plate 16 that is disposed so as to overlap the side opposite to a display surface 11c of the liquid crystal panel 11 and that has end faces facing the LEDs 17; a chassis 14 disposed on the side of the light guide plate 16 opposite to the liquid crystal panel 11; a light transmissive panel 13 that is arranged so as to overlap the display surface 11c of the liquid crystal panel 11, that houses the LEDs 17 between the light transmissive panel 13 and the chassis 14, and that sandwiches the liquid crystal panel 11 and the light guide plate 16 while allowing light to pass through; and a light-shielding member 25 that is disposed on the light transmissive panel 13 surrounding a display area AA of the liquid crystal panel 11 and that blocks light around the display area AA, a part of the light-shielding member being made of a transparent part 26 that allows light to pass through.

### TECHNICAL FIELD

The present invention relates to a display device and a television receiver.

### BACKGROUND ART

In recent years, flat panel display devices that use flat panel display elements such as liquid crystal panels and plasma display panels are increasingly used as display elements for image display devices such as television receivers instead of conventional cathode-ray tube displays, allowing image display devices to be made thinner. An example of such a panel display device is disclosed in Patent Document 1 below, the configuration of which is designed to make a device using a plasma display panel thinner or the like.

### RELATED ART DOCUMENT

### Patent Document

Patent Document 1: Japanese Patent Application Laid-Open Publication No. 2005-70661

### Problems to be Solved by the Invention

However, in a liquid crystal display device, which is one type of panel display device, a liquid crystal panel used therein does not emit light, and therefore, it is necessary to separately provide a backlight device as an illumination device. The backlight devices are largely categorized into a direct-lit type and an edge-lit type depending on the mechanism thereof. To achieve a further thickness reduction of the liquid crystal display device, it is preferable to use an edge-lit backlight device.

Conventionally, in a liquid crystal display device with such an edge-lit backlight device, the liquid crystal panel is sandwiched between a pressing member on the front side and a panel receiving member on the rear side. In order to satisfy demands for a reduction in manufacturing cost or a further reduction in thickness and the like, elimination of the panel receiving member on the rear side is possible, for example. However, the panel receiving member is interposed between the light source and the liquid crystal panel, and has the function of blocking light from the light source from directly entering an edge of the liquid crystal panel, and therefore, if the panel receiving member is simply eliminated, light from the light source would directly enter the edge of the liquid crystal panel, and there is a risk that light leakage could occur around the display area. If a light transmissive panel instead of a pressing member is disposed so as to overlap the display surface side of the liquid crystal panel, for example, in order to enhance the design characteristics and protect the liquid crystal panel, then there is a risk that light that has directly entered the edge of the liquid crystal panel will go through the light transmissive panel and leak to an area around the display area, or that light from the light sources will go directly through the light transmissive panel and leak to an area around the display area.

### SUMMARY OF THE INVENTION

The present invention was completed in view of the above-mentioned situation, and aims at giving new added value to the display device in addition to preventing light leakage.

### Means for Solving the Problems

The display device of the present invention includes: a light source; a display panel having a display surface capable of displaying an image by using light from the light source and a display area within the display surface, the display area being where the image is displayed; a light guide plate that is disposed so as to overlap a side of the display panel opposite to the display surface and that has an end face opposing the light source; a chassis disposed on a side of the light guide plate opposite to the display panel; a light transmissive panel that is disposed so as to cover the display panel on the side of the display surface and that allows light to pass through, the light transmissive panel and the chassis sandwiching the display panel and the light guide plate while housing the light source therebetween; and a light-shielding member provided to the light transmissive panel, the light-shielding member being arranged so as to surround the display area of the display panel to block light around the display area, a part of the light-shielding member being made of a transparent part that allows light to pass therethrough.

In this way, the light emitted from the light source will enter the opposing end face of the light guide plate and then be guided to the display panel; therefore, an image is displayed on the display area of the display surface of the display panel by using this light. The light transmissive panel, by being arranged so as to overlap the display panel on the display surface side, can enhance the design characteristics of the display device and protect the display panel, and also allow light emitted from the display panel to pass through. Thus, the light transmissive panel will not block the display.

The display panel and light guide plate are sandwiched so as to overlap each other by the light transmissive panel and chassis from the display surface side and the opposite side thereof, and the liquid crystal panel is not sandwiched by a panel pressing member on the front side and a panel receiving member on the rear side, as is conventional; thus, there is a risk that light from the light source will leak to an area around the display area by passing through the light transmissive panel without going through the light guide plate.

As a countermeasure, a light-shielding member that blocks light around the display area is provided on the light transmissive panel surrounding the display area, and therefore, light can be prevented from being emitted from the light transmissive panel around the display area. Furthermore, the transparent part that allows light to pass through is formed in a portion of the light-shielding member; therefore, a portion of the light blocked by the light-shielding member is emitted by the transparent part from the light transmissive panel in at least a portion around the display area, thereby making it possible to display a prescribed trademark (letter, figure, symbol, etc.), design mark, or the like, for example, corresponding to the shape of the transparent part. This allows added value in the form of a new and non-conventional design to be provided to the liquid crystal display device.

As embodiments of the present invention, the following configurations are preferred.

(1) A light diffusing member that diffuses light from the light source is interposed between the transparent part and the light source. In this way, light from the light source is diffused by the light diffusing member interposed between the transparent part and the light source, thereby supplying the transparent part with this light from the light diffusing member and making it difficult for uneven brightness to occur with the light that passes through the transparent part. This can raise the display quality of the transparent part and is excellent for design characteristics and the like.

(2) The light diffusing member is disposed on the outside of the display panel and abutting an end face of the display panel. In this way, the display panel can be positioned due to the light diffusing member arranged on the outside of the display panel abutting the end face of the display panel, which is excellent for assembly workability and the like during manufacturing. Due to the light diffusing member for diffusing light from the light source also having this positioning function for the display panel, the number of components can be reduced and the like as compared to if a separate positioning member were provided in addition to the light diffusing member.

(3) The light diffusing member faces the transparent part and abuts a surface of the light transmissive panel on the display panel side. In this way, the light that is diffused and emitted by the light diffusing member can more reliably reach the transparent part.

(4) The light diffusing member is integrally fixed to the light transmissive panel. In this way, it is harder for a gap to form between the light transmissive panel and the light diffusing member due to the light diffusing member being fixed to the light transmissive panel; therefore, the light emitted by the light diffusing member can more reliably enter the transparent part. This is excellent for assembly workability during manufacturing of the display device.

(5) The light diffusing member is formed at least from the light source to an end face of the light guide plate, as seen from the display surface side. In this way, a large amount of light from the light source will be present between the light source and the end face of the light guide plate; therefore, light can more reliably reach the transparent part by this being diffused by the light diffusing member.

(6) A wavelength-selective light transmissive member that selectively allows a certain wavelength of visible light to pass through is attached to the light diffusing member. In this way, light of a specific wavelength that has selectively passed through the wavelength-selective light transmissive member can be supplied to the transparent part; therefore, the presentation and design characteristics of the display of the transparent part can be further enhanced.

(7) The light-shielding member is disposed on a surface of the light transmissive panel on the display panel side. In this way, light from the light source will be blocked by the light-shielding member, except at the transparent part around the display area, before being radiated onto the light transmissive panel. Thus, even if light is radiated onto the light transmissive panel, light leakage from the end face of the light transmissive panel or the like can be prevented. The light-shielding member can avoid being exposed to outside of the light transmissive panel, and therefore, it is difficult for the light-shielding member to be damaged or the like, and this is suitable for securing the light blocking function.

(8) A screw receiving member that is disposed on a surface of the light transmissive panel on the display panel side and that has a screw receiving section protruding towards the chassis; and a screw that sandwiches the chassis between the screw and the screw receiving section by being fastened to the screw receiving section while penetrating the chassis are further included. In this way, when the screw is fastened to the screw part of the screw receiving member, the chassis holds the display panel and light guide plate in a sandwiched state with respect to the light transmissive panel where the screw receiving member is disposed. As such, the light transmissive panel can have a holding function with respect to the chassis.

(9) A light source attachment member that has a light source attachment section that is disposed on a side of the light source opposite to the light guide plate and that is where the light source is attached, and a heat dissipating section that faces the screw receiving section and that makes surface-to-surface contact with the chassis, wherein the screw sandwiches the chassis and the heat dissipating section between the screw and the screw receiving section. In this way, the heat dissipating section and the chassis can be held together in a sandwiched state between the screw and the screw receiving section, and thus, the positional relationship between the light source attached to the light source attachment member having the heat dissipating section and the light guide plate being held by the light transmissive panel and the chassis can be maintained, and the incidence efficiency of light entering the light guide plate from the light source can be stabilized. The heat generated by the light source can be efficiently transmitted from the heat dissipating section towards the chassis, which allows the heat dissipating characteristics to be improved.

(10) The display panel is a liquid crystal panel made of liquid crystal sealed between a pair of substrates. As a liquid crystal display device, such a display device can be applied to various applications such as a television or the display of a personal computer, for example, and is particularly suitable for large screens.

### Effects of the Invention

According to the present invention, light leakage can be prevented and a new added value can be provided to the display device.

### BRIEF DESCRIPTION OF THE DRAWINGS

FIG. 1 is an exploded perspective view that shows a schematic configuration of a television receiver and a liquid crystal display device according to Embodiment 1 of the present invention.

FIG. 2 is a rear view of the television receiver and the liquid crystal display device.

FIG. 3 is an exploded perspective view showing a schematic configuration of a liquid crystal display unit that constitutes a part of the liquid crystal display device.

FIG. 4 is a cross-sectional view that shows a cross-sectional configuration of the liquid crystal display device along the shorter side direction.

FIG. 5 is an exploded perspective view showing a screw receiving member, a spacer member, and an LED unit.

FIG. 6 is a cross-sectional view of FIG. 5 along the line vi-vi.

FIG. 7 is a cross-sectional view of FIG. 5 along the line vii-vii.

FIG. 8 is a plan view of the light transmissive panel.

FIG. 9 is a cross-sectional view of FIG. 5 along the line vi-vi, showing a work procedure to assemble respective constituting members of the liquid crystal display unit that constitutes a part of the liquid crystal display device.

FIG. 10 is a plan view of the light transmissive panel according to Modification Example 1 of Embodiment 1.

FIG. 11 is a plan view of the light transmissive panel according to Modification Example 2 of Embodiment 1.

FIG. 12 is a plan view of the light transmissive panel according to Modification Example 3 of Embodiment 1.

FIG. 13 is a plan view of the light transmissive panel according to Modification Example 4 of Embodiment 1.

FIG. 14 is a cross-sectional view showing a cross-sectional configuration of a liquid crystal display device of Embodiment 2 of the present invention along the shorter side direction.

FIG. 15 is a cross-sectional view showing a cross-sectional configuration of a liquid crystal display device of Embodiment 3 of the present invention along the shorter side direction.

FIG. 16 is a cross-sectional view showing a cross-sectional configuration of a liquid crystal display device of Embodiment 4 of the present invention along the shorter side direction.

FIG. 17 is a cross-sectional view showing a cross-sectional configuration of a liquid crystal display device of Embodiment 5 of the present invention along the shorter side direction.

### DETAILED DESCRIPTION OF EMBODIMENTS

### Embodiment 1

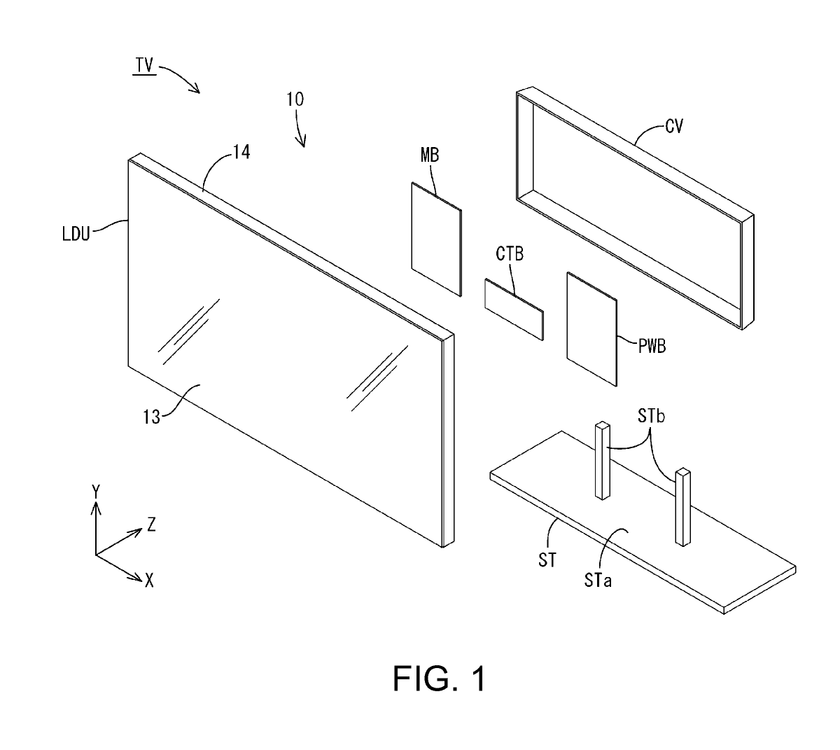

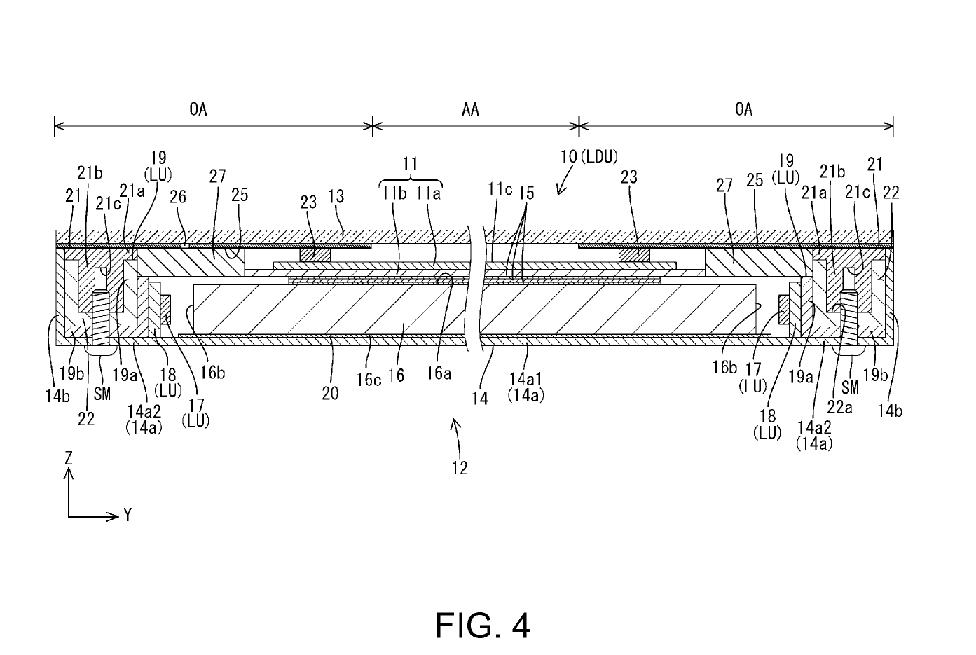

Embodiment 1 of the present invention will be described with reference to FIGS. 1 to 9. In the present embodiment, a liquid crystal display device 10 will be described as an example. The drawings indicate an X axis, a Y axis, and a Z axis in a portion of the drawings, and each of the axes indicates the same direction for the respective drawings. The upper side of FIG. 4 is the front side, and the lower side is the rear side.

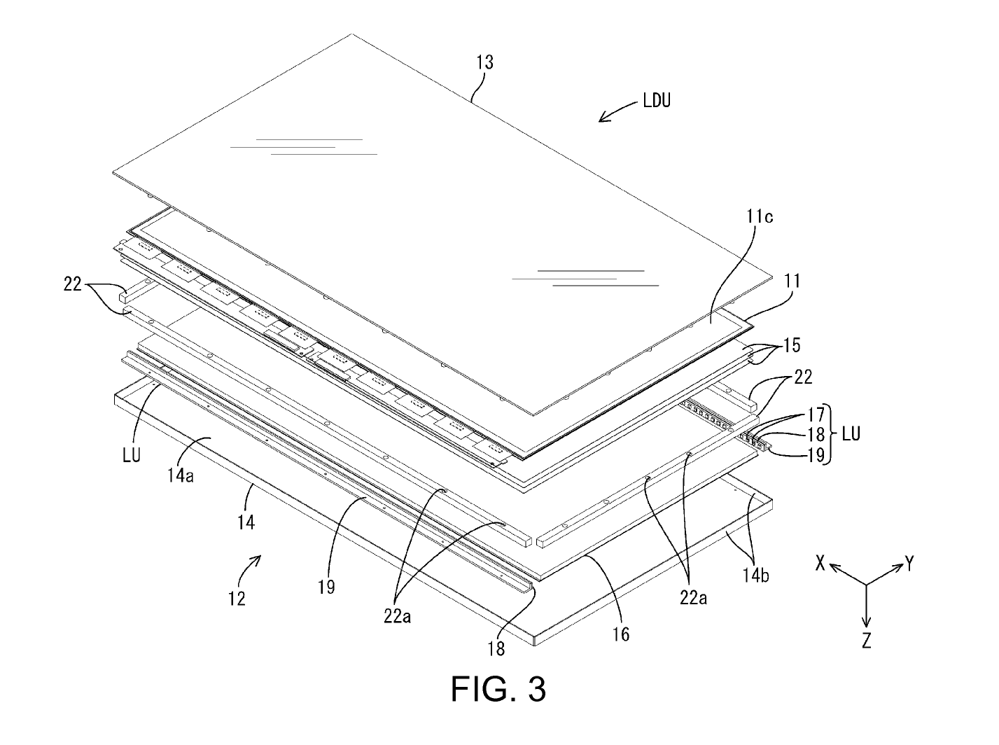

As shown in FIG. 1, a television receiver TV according to the present embodiment has a liquid crystal display unit (display unit) LDU, various boards PWB, MB, and CTB attached to the rear side (back side) of the liquid crystal display unit LDU, a cover member CV that is attached to the rear side of the liquid crystal display unit LDU and covers the various boards PWB, MB, and CTB, and a stand ST. The television receiver TV is supported by the stand ST in a state in which the display surface of the liquid crystal unit LDU coincides with the vertical direction (Y axis direction). The liquid crystal display device 10 of the present embodiment is the portion excluding the configuration for receiving television signals (such as a tuner part of the main board MB) from the television receiver TV having the above-mentioned configuration. As shown in FIG. 3, the liquid crystal display unit LDU has a liquid crystal panel 11, which is a display panel, with a horizontally long quadrangular shape (rectangular shape) as a whole, and a backlight device (illumination device) 12, which is an external light source. These are integrally held together by a light transmissive panel (a first exterior member) 13 and a chassis (a second exterior member) 14, which are exterior members that form the exterior of the liquid crystal display device 10. The chassis 14 of the present embodiment constitutes one of the exterior members and also a part of the backlight device 12.

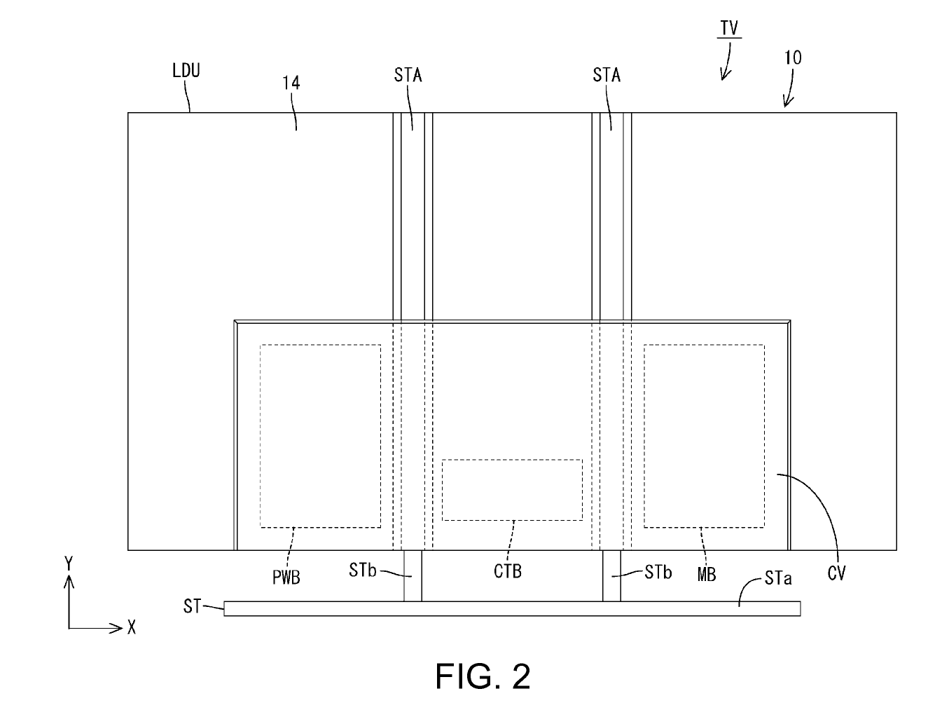

First, the configuration of the rear side of the liquid crystal display device 10 will be explained. As shown in FIG. 2, on the rear of the chassis 14 that constitutes the rear exterior of the liquid crystal display device 10, a pair of stand attachment members STA extending along the Y axis direction is attached at two locations that are separated from each other along the X axis direction. The cross-sectional shape of these stand attachment members STA is a substantially channel shape that opens toward the chassis 14, and a pair of support columns STb of the stand ST is inserted into spaces formed between the stand attachment members STA and the chassis 14, respectively. Wiring members (such as electric wires) connected to an LED substrate 18 of the backlight device 12 run through a space inside of the stand attachment members STA. The stand ST is constituted of a base STa that is disposed in parallel with the X axis direction and the Z axis direction, and a pair of support columns STb standing on the base STa along the Y axis direction. The cover member CV is made of a synthetic resin, and is attached so as to cover a portion, or more specifically about a half of the lower part of the rear side of the chassis 14 of FIG. 2, while extending across the pair of stand attachment members STA along the X axis direction. Between the cover member CV and the chassis 14, a component housing space is provided to house the components mentioned below such as the various boards PWB, MB, and CTB.

As shown in FIG. 2, the various boards PWB, MB, and CTB include a power supply board PWB, a main board MB, and a control board CTB. The power supply board PWB is a power source for the liquid crystal display device 10, and can supply driving power to other boards MB and CTB, LEDs 17 of the backlight device 12, and the like. Therefore, the power supply board PWB doubles as an LED driver board that drives the LEDs 17. The main board MB has at least a tuner part that can receive television signals, and an image processing part that conducts image-processing on the received television signals (neither the tuner part or the image processing part is shown in the figure), and can output the processed image signals to the control board CTB described below. When the liquid crystal display device 10 is connected to an external video playback device that is not shown, an image signal from the video playback device is inputted into the main board MB, and the main board MB can output the image signal to the control board CTB after processing the signal at the image processing part. The control board CTB has the function of converting the image signal inputted from the main board MB to a signal for driving liquid crystal, and supplying the converted signal for liquid crystal driving to the liquid crystal panel 11.

As shown in FIG. 3, the liquid crystal display unit LDU constituting the liquid crystal display device 10 is formed by being housed in the space between where the main constituting components thereof are held, namely between the light transmissive panel (front panel) 13 forming the exterior of the front side and the chassis (rear chassis) 14 forming the exterior of the rear side. The main constituting components housed between the light transmissive panel 13 and the chassis 14 include at least the liquid crystal panel 11, optical members 15, a light guide plate 16, and an LED unit (light source unit) LU. Of these, the liquid crystal panel 11, optical members 15, and light guide plate 16 are held by being sandwiched between the light transmissive panel 13 on the front side and the chassis 14 on the rear side while being stacked on each other. The backlight device 12 is constituted of the optical members 15, the light guide plate 16, the LED units LU, and the chassis 14, and is the configuration of the liquid crystal display unit LDU described above excluding the liquid crystal panel 11 and the light transmissive panel 13. A pair of LED units LU, which is a part of the backlight device 12, is disposed between the light transmissive panel 13 and the chassis 14 so as to be on the respective sides of the light guide plate 16 in the shorter side direction (Y axis direction). The LED unit LU is constituted of the LEDs 17, which are the light source, an LED substrate (light source substrate) 18 on which the LEDs 17 are mounted, and a heat dissipating member (heat spreader, light source attachment member) 19 to which the LED substrate 18 is attached. The respective constituting components will be explained below.

As shown in FIG. 3, the liquid crystal panel 11 is formed in a horizontally long quadrangular shape (rectangular shape) in a plan view, and is configured by bonding a pair of glass substrates 11a and 11b having high light transmittance to each other with a prescribed gap therebetween, and by injecting liquid crystal between the two substrates 11a and 11b. Of the two substrates 11a and 11b, one on the front side (front surface side) is a CF substrate 11a, and the other on the rear side (rear surface side) is an array substrate 11b. In the array substrate 11b on the rear side, switching elements (TFTs, for example) connected to source wiring lines and gate wiring lines that are intersecting with each other, pixel electrodes connected to the switching elements, an alignment film, and the like are provided. As shown in FIG. 4, the array substrate 11b is formed larger than the CF substrate 11a in a plan view, and is disposed such that an edge portion thereof protrudes toward the outside beyond the CF substrate 11a. On the other hand, in the CF substrate 11a on the front side, color filters having respective colored portions such as R (red), G (green), and B (blue) arranged in a prescribed pattern, an opposite electrode, an alignment film, and the like are provided. Polarizing plates are respectively provided on outer sides of the two substrates.

As shown in FIGS. 3 and 4, the liquid crystal panel 11 is stacked on the front side of the optical members 15 described below, and the rear surface thereof (outer surface of a polarizing plate on the rear side) is in close contact with the optical members 15 with almost no gap. With this configuration, it is possible to prevent dust and the like from entering a space between the liquid crystal panel 11 and the optical members 15. A display surface 11c of the liquid crystal panel 11 is constituted of a display area AA that is in the center of the screen and that can display images, and a non-display area that is on the outer edges of the screen and that is formed in a frame shape surrounding the display area AA. The control board CTB is connected to this liquid crystal panel 11 through the a liquid crystal driver component, FPC, or the like, and images are displayed on the display area AA on the display surface 11c of the liquid crystal panel 11 on the basis of signals inputted from the control board CTB.

As shown in FIG. 3, the optical members 15 have a horizontally-long quadrangular shape in a plan view similar to the liquid crystal panel 11, and the size thereof (shorter side dimensions and longer side dimensions) is similar to that of the liquid crystal panel 11. The optical members 15 are stacked on the front side (side from which light is emitted) of the light guide plate 16 described below, and are sandwiched between the liquid crystal panel 11 described above and the light guide plate 16. Each of the optical members 15 is a sheet-shaped member, and the optical members 15 are constituted of three sheets stacked together. Specific types of optical members 15 include a diffusion sheet, a lens sheet, a reflective polarizing sheet, and the like, for example, and it is possible to appropriately choose any of these as optical members 15.

The light guide plate 16 is made of a synthetic resin (an acrylic resin such as PMMA or a polycarbonate, for example) with a refractive index sufficiently higher than air and almost completely transparent (excellent light transmission). As shown in FIG. 3, the light guide plate 16 has a horizontally-long quadrangular shape in a plan view, in a manner similar to the liquid crystal panel 11 and the optical members 15, and has a plate shape that is thicker than the optical members 15. The longer side direction on the main surface of the light guide plate 16 corresponds to the X axis direction, the shorter side corresponds to the Y axis direction, and the plate thickness direction intersecting the main surface corresponds to the Z axis direction. The light guide plate 16 is stacked on the rear side of the optical members 15, and is sandwiched between the optical members 15 and the chassis 14. As shown in FIG. 4, in the light guide plate 16, at least the shorter side dimensions thereof are greater than the respective shorter side dimensions of the liquid crystal panel 11 and the optical members 15, and the light guide plate 16 is disposed such that respective edges in the shorter side direction (respective edges along the longer side direction) protrude outward beyond respective edges of the liquid crystal panel 11 and the optical members 15 (so as not to overlap in a plan view). The light guide plate 16 is sandwiched in the Y axis direction between the pair of LED units LU disposed on both edges of the light guide plate 16 facing each other in the shorter side direction thereof. Light from the LEDs 17 enters both respective edges of the shorter side direction. The light guide plate 16 has the function of guiding therethrough light from the LEDs 17 that entered from the respective edges facing each other in the shorter side direction and emitting the light toward the optical members 15 (front side) while internally propagating this light.

Of the main surfaces of the light guide plate 16, the surface facing the front side (surface facing the optical members 15) is a light exiting surface 16a where internal light exits towards the optical members 15 and the liquid crystal panel 11. Of the peripheral end faces of the light guide plate 16 adjacent to the main surface thereof, the end faces (the end faces of both edges facing each other in the shorter direction) on the longer sides that form a rectangular shape along the X axis direction constitute a pair of light receiving faces 16b where light emitted from the LEDs 17 enter. These light receiving faces 16b each directly face the respective LEDs 17 (LED substrates 18) with a prescribed gap therebetween. The light receiving faces 16b are on a plane parallel to that defined by the X axis direction and the Z axis direction (main surface of the LED substrate 18), and are substantially perpendicular to the light exiting surface 16a. The direction at which the LEDs 17 and the light receiving faces 16b are aligned with respect to each other corresponds to the Y axis direction, and is parallel to the light exiting surface 16a.

As shown in FIG. 4, on the rear side of the light guide plate 16, or in other words, on a surface 16c that is opposite to the light exiting surface 16a (surface facing the chassis 14), a light guide reflective sheet 20 is disposed so as to cover almost the entire area of the surface 16c. The light guide reflective sheet 20 can reflect light, which exits out from the surface 16c toward the rear side, back to the front side. In other words, the light guide reflective sheet 20 is sandwiched between the chassis 14 and the light guide plate 16. The light guide reflective sheet 20 is made of a synthetic resin, and the surface thereof is a highly reflective white. The shorter side dimensions of the light guide reflective sheet 20 are greater than the shorter side dimensions of the light guide plate 16, and the respective edges thereof protrude beyond the light receiving faces 16b of the light guide plate 16 towards the LEDs 17. With the protruding portions of the light guide reflective sheet 20, light that travels diagonally from the LEDs 17 towards the chassis 14 can be reflected efficiently, thereby directing the light toward the light receiving faces 16b of the light guide plate 16. On at least one of either the light exiting surface 16a of the light guide plate 16 or the opposite face 16c thereto, reflective parts (not shown) that reflect internal light or diffusing parts (not shown) that diffuse internal light are patterned so as to have a prescribed planar distribution, and this controls the emitted light from the light exiting surface 16a such that the light has a uniform distribution in the plane.

Next, configurations of the LEDs 17, the LED substrates 18, and the heat dissipating member 19 that constitute the LED unit LU will be explained in this order. As shown in FIGS. 3 and 4, the LEDs 17 of the LED units LU have a configuration in which an LED chip is sealed with a resin on a substrate part that is affixed to the LED substrate 18. The LED chip mounted on the substrate part has one type of primary light-emitting wavelength, and specifically, only emits blue light. On the other hand, the resin that seals the LED chips has a fluorescent material dispersed therein, the fluorescent material emitting light of a prescribed color by being excited by the blue light emitted from the LED chip. This combination of the LED chips and the fluorescent material causes white light to be emitted overall. As the fluorescent material, a yellow fluorescent material that emits yellow light, a green fluorescent material that emits green light, and a red fluorescent material that emits red light, for example, can be appropriately combined, or one of them can be used on its own. The LEDs 17 are of a so-called top-type in which the side opposite to that mounted onto the LED substrates 18 is the light-emitting surface.

As shown in FIGS. 3 and 4, the LED substrates 18 constituting the LED units LU have an elongated plate shape extending along the longer side direction (X axis direction/lengthwise direction of the light receiving face 16b) of the light guide plate 16, and the main surface of each of the LED substrates 18 is parallel to the X axis direction and Z axis direction. In other words, the LED substrates 18 are respectively housed inside the light transmissive panel 13 and chassis 14 while parallel to the light receiving faces 16b of the light guide plate 16. On the inner main surfaces of the respective LED substrates 18, or in other words, on the surfaces facing the light guide plate 16 (surfaces opposing the light guide plate 16), the LEDs 17 having the above-mentioned configuration are mounted, and these surfaces are mounting surfaces 18a. On the mounting surfaces 18a of the LED substrates 18, a plurality of LEDs 17 are arranged in a row (in a line) along the length direction (X axis direction) at prescribed intervals. That is, a plurality of LEDs 17 are arranged at intervals along the longer side direction on the respective longer edges of the backlight device 12. The intervals between respective adjacent LEDs 17 along the X axis direction are substantially equal to each other, or in other words, the LEDs 17 are arranged at substantially the same pitch. The arrangement direction of the LEDs 17 corresponds to the length direction (X axis direction) of the LED substrates 18. Wiring patterns (not shown) made of a metal film (copper foil or the like) are formed on the mounting surface 18a of each of the LED substrates 18, and these wiring patterns extend along the X axis direction and go across the group of LEDs 17 to connect the adjacent LEDs 17 in series. Terminals formed at both respective edges of these wiring patterns connect to the power supply board PWB through a wiring member such as a connector or cable and supply driving power to each of the LEDs 17. The pair of LED substrates 18 are housed inside the light transmissive panel 13 and chassis 14 while the mounting surfaces 18a of the LEDs 17 face each other; therefore, the main light-emitting surface of each of the LEDs 17 mounted on both of the respective LED substrates 18 face each other, and the optical axis of the respective LEDs 17 approximately corresponds to the Y axis direction. The base member of the LED substrate 18 is made of a metal such as aluminum, for example, and the above-described wiring pattern (not shown) is formed on the surface via an insulating layer. It is also possible to use an insulating material such as a ceramic as the base material for the LED substrates 18.

As shown in FIGS. 3 and 4, the heat dissipating member 19 of the LED unit LU is made of a metal such as aluminum, for example, that has excellent heat conductivity. The heat dissipating member 19 is constituted of an LED attachment section (light source attachment section) 19a to which the LED substrate 18 is attached, and a heat dissipating section 19b that makes surface-to-surface contact with the plate surface of the chassis 14, and these two sections form a bent shape having a substantially L-shaped cross section. The LED attachment section 19a has a plate shape that runs parallel to the surface of the LED substrate 18 and the light receiving face 16b of the light guide plate 16, and the longer side direction corresponds to the X axis direction, the shorter side direction corresponds to the Z axis direction, and the thickness direction corresponds to the Y axis direction, respectively. The inner surfaces of the LED attachment section 19a, namely the surfaces facing the light guide plate 16, have LED substrates 18 attached respectively thereto. In other words, the LED attachment section 19a is arranged on the side of the LEDs 17 and LED substrates 18 that is opposite to the light guide plate 16, and is attached to the surface that is opposite to the mounting surface 18a of the LED substrate 18. While the longer side dimensions of the LED attachment section 19a are substantially similar to the longer side dimensions of the LED substrate 18, the shorter side dimensions of the LED attachment section 19a are greater than the shorter side dimensions of the LED substrate 18. The respective edges of the LED attachment section 19a in the shorter side direction protrude outward beyond the respective edges of the LED substrate 18 along the Z axis direction. The exterior surface of the LED attachment section 19a, namely the surface that is opposite to the surface where the LED substrate 18 is attached, faces a screw receiving section 21b of a screw receiving member 21 of the light transmissive panel 13, described later. In other words, the LED attachment section 19a is interposed between the screw receiving section 21b of the light transmissive panel 13 and the light guide plate 16. The LED attachment section 19a is configured to rise from the inner edge, or in other words, the edge of the heat dissipating section 19b described below closer to the LEDs 17 (light guide plate 16) towards the front side, or towards the light transmissive panel 13 along the Z axis direction.

As shown in FIGS. 3 and 4, the heat dissipating section 19b is formed in a plate shape that is parallel to the surface of the chassis 14, and the longer side direction corresponds to the X axis direction, the shorter side direction corresponds to the Y axis direction, and the thickness direction corresponds to the Z axis direction, respectively. The rear surface of the heat dissipating section 19b, or in other words, the surface facing the chassis 14, makes surface-to-surface contact with the surface of the chassis 14. Due to this, heat generated by the LEDs 17 is transmitted towards the chassis 14 through the LED substrate 18, LED attachment section 19a, and heat dissipating section 19b, thereby effectively dissipating the heat to outside of the liquid crystal display device 10 and making it difficult for the heat to be trapped inside. The longer side dimensions of the heat dissipating section 19b are substantially the same as that of the LED attachment section 19a. The front surface of the heat dissipating section 19b, or in other words, the surface opposite to the surface that is in contact with the chassis 14, faces the screw receiving section 21b of the screw receiving member 21 of the light transmissive panel 13, which will be described later. In other words, the heat dissipating section 19b is interposed between the screw receiving section 21b of the light transmissive panel 13 and the chassis 14. The heat dissipating section 19b is configured to be attached to the screw receiving section 21b by a screw SM, and has an insertion hole 19b1 for the screw SM to go therethrough. The heat dissipating section 19b protrudes from the rear edge, or in other words, the edge closer to the chassis 14, of the LED attachment section 19a towards the outside, or in other words, in the direction opposite to the light guide plate 16.

Next, the configuration of the light transmissive panel 13 and chassis 14, which form the exterior members, will be explained. As shown in FIG. 3, the light transmissive panel 13 and the chassis 14 hold the liquid crystal panel 11, the optical members 15, and the light guide plate 16, which are stacked on top of the other, by sandwiching these stacked components from the front side and the rear side, while housing the pair of LED units LU on the respective edges in the shorter side direction.

As shown in FIG. 3, the light transmissive panel 13 has excellent transmissive characteristics and is made of an almost transparent glass (soda-lime glass or the like, for example); therefore, light that is radiated from the display area AA on the display surface 11c of the liquid crystal panel 11 arranged on the rear side of the light transmissive panel 13 can be emitted towards the external front side without being blocked. The light transmissive panel 13 has a horizontally-long quadrangular shape in a plan view similar to the liquid crystal panel 11, optical members 15, and the light guide plate 16. The size of the light transmissive panel 13 in a plan view is larger than the liquid crystal panel 11, optical members 15, and light guide plate 16, and is approximately the same size as the outer shape of the liquid crystal display device 10 (chassis 14). Accordingly, as shown in FIG. 1, when a user (viewer) views the liquid crystal display device 10 of the present embodiment from the front, a clear image can be shown to the user (viewer) and excellent design characteristics can be achieved by the light transmissive panel 13 being arranged on the entire outer shape of the liquid crystal display device 10. This light transmissive panel 13 is a so-called tempered glass that is provided with a chemically strengthened layer on the surface thereof by performing a chemical strengthening treatment on this surface. This chemical strengthening treatment uses ion exchange to strengthen the light transmissive panel 13 by substituting an alkali metal ion contained in the material constituting the light transmissive panel 13 with an alkali metal ion that has a larger ion radius. The chemically strengthened layer resulting from this treatment is a compressive strength layer (ion exchange layer) that has residual compressive stress. Due to this, the light transmissive panel 13 has high mechanical strength and shock-proof properties, and thus, the liquid crystal panel 11 on the rear side thereof can be firmly protected.

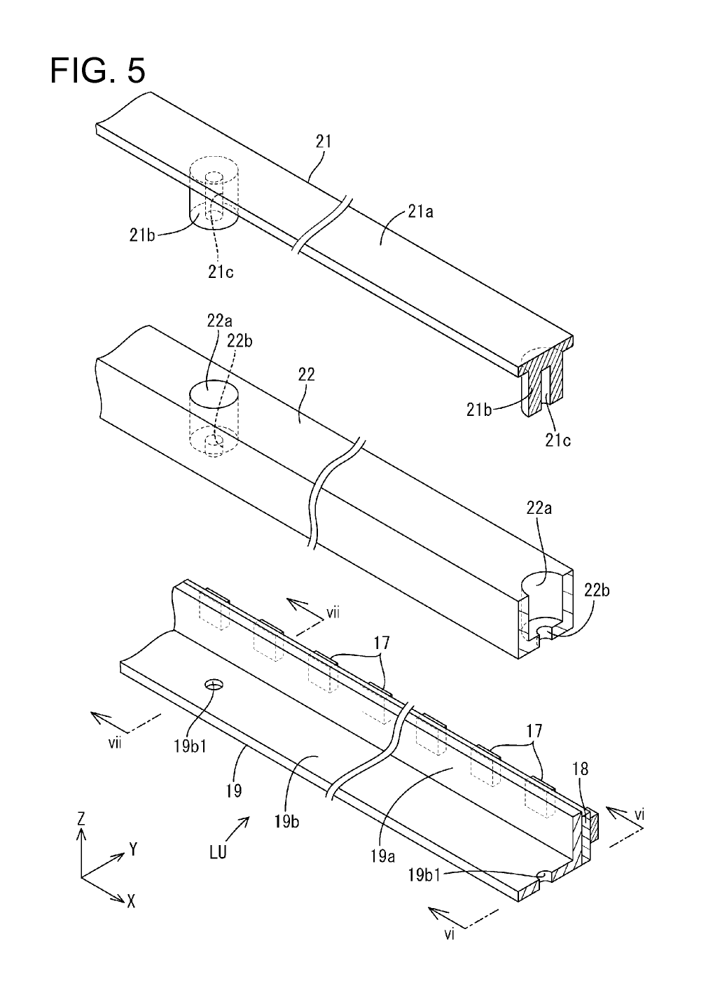

As shown in FIG. 3, the screw receiving member 21, which is where the screw SM for holding the chassis 14 and LED unit LU in place is fastened, is disposed on the light transmissive panel 13. The screw receiving member 21 is made of a metal (aluminum, iron, or the like, for example), which is a material with light blocking characteristics, and is integrally fixed to the rear surface of the light transmissive panel 13, or in other words, the surface of the light transmissive panel 13 on the liquid crystal panel 11 side (chassis 14 side) by a fixing member such as an adhesive. As shown in FIGS. 4 and 5, the screw receiving member 21 is constituted of a frame-shaped base part 21a that extends along the outer periphery of the light transmissive panel 13, and a plurality of screw receiving sections 21b that protrude from the frame-shaped base part 21a towards the rear side. The frame-shaped base part 21a is a plate with a horizontally-long quadrangular shape in a plan view, and is attached such that the front surface thereof is in contact with the surface of the rear side of the light transmissive panel 13 at a location slightly more inward than the outer edges of the light transmissive panel 13. The external dimensions of the frame-shaped base part 21a are slightly smaller than the external dimensions of the light transmissive panel 13, whereas the internal dimensions of the frame-shaped base part 21a are greater than the external dimensions of the liquid crystal panel 11, optical members 15, and light guide plate 16. In other words, the frame-shaped base part 21a is in a positional relationship not overlapping the liquid crystal panel 11, optical members 15, and light guide plate 16 in a plan view (seen from the front). Meanwhile, the frame-shaped base part 21a is in a positional relationship overlapping the heat dissipating member 19 that forms the LED unit LU in a plan view.

As shown in FIGS. 4 and 5, the screw receiving section 21b has a substantially cylindrical shape that protrudes from the rear (the side opposite to the light transmissive panel 13) surface of the frame-shaped base part 21a towards the rear side along the Z axis direction. A plurality of the screw receiving sections 21b are respectively disposed in parallel at intervals in the extension direction of the respective sides of the frame-shaped base parts 21a on the pair of longer sides and on the pair of shorter sides of the frame-shaped base parts 21a (see FIG. 3). The respective screw receiving sections 21b on both longer sides of the frame-shaped base part 21a face the heat dissipating section 19b of the heat dissipating member 19 constituting the LED unit LU that is arranged on the rear side of the screw receiving section 21b. The respective screw receiving sections 21b also face the LED attachment section 19a of the heat dissipating member 19 arranged inside the liquid crystal display device 10. In other words, these screw receiving sections 21b are in a positional relationship overlapping the heat dissipating section 19b of the heat dissipating member 19 in a plan view, and in a positional relationship overlapping the LED attachment section 19a of the heat dissipating member 19 in a plan view. A screw hole 21c that opens to the rear is formed in the center of the screw receiving section 21b, and the shaft of the screw SM is screwed into here from the rear.

As shown in FIGS. 4 and 5, a spacer member 22 is interposed between the above-mentioned screw receiving section 21b and heat dissipating member 19. As shown in FIGS. 3 and 5, a total of four of the spacer members 22 are each made of a synthetic resin and have a substantially square bar shape extending along the respective sides of the pair of longer sides and shorter sides of the frame-shaped base part 21a. Recessed portions 22a that are open in the front and that individually engage the respective screw receiving sections 21b are formed in each of the spacer members 22. A plurality of the recessed portions 22a are disposed at intervals along the extension direction of each of the spacer members 22, and the arrangement of the recessed portions 22a are configured so as to match the arrangement of the screw receiving sections 21b. As shown in FIGS. 4 and 5, an insertion hole 22b is formed penetrating the bottom of the recessed portions 22a of the respective spacer members 22. This insertion hole 22b matches the screw hole 21c of the respective screw receiving sections 21b and the shaft of the screw SM can be inserted therein. Of the four spacer members 22, the pair of spacer members 22 on the longer side are sandwiched between the screw receiving section 21b and the heat dissipating section 19b of the heat dissipating member 19, whereas the pair of spacer members 22 on the shorter side are sandwiched between the screw receiving section 21b and the chassis 14 without going through the heat dissipating section 19b (see FIG. 3).

As shown in FIG. 4, cushioning members 23 are disposed on the rear surface of the light transmissive panel 13 between the light transmissive panel 13 and the liquid crystal panel 11. The cushioning member 23 is made of a foamed resin material or the like, for example, and has excellent cushioning performance due to this. The cushioning member 23 is a horizontally-long quadrangular frame shape, similar to the outer shape of the liquid crystal panel 11. The cushioning member 23 abuts the area (non-display area) surrounding the display area AA of the liquid crystal panel 11. The cushioning member 23 is integrally fixed to the light transmissive panel 13 by an adhesive double-sided tape, or the like.

The chassis 14 is made of a metal such as aluminum, for example, and has higher mechanical strength (rigidity) and heat conductivity as compared to if the chassis 14 were made of a synthetic resin. As shown in FIG. 3, the chassis 14 is formed in a substantially shallow plate shape that is horizontally long as a whole so as to almost entirely cover the light guide plate 16, the LED units LU, and the like from the rear side. The rear outer surface of the chassis 14 (surface opposite to the side facing the light guide plate 16 and the LED units LU) is exposed to the outside on the rear side of the liquid crystal display device 10, and constitutes the rear surface of the liquid crystal display device 10.

As shown in FIGS. 3 and 4, the chassis 14 is constituted of a bottom 14a that has a horizontally-long quadrangular shape similar to the light transmissive panel 13, and side walls 14b that respectively rise up towards the front of the liquid crystal display device from a pair of longer side edges and a pair of shorter side edges of the bottom 14a. The bottom 14a has a flat plate shape having a size that is approximately the same as the light transmissive panel 13 in a plan view. The center in the shorter side direction of the bottom 14a is a light guide plate receiving part 14a1 that receives all areas of the light guide plate 16 from the rear side, whereas both edges in the shorter side direction are LED unit receiving parts 14a2 that each receive a pair of the LED units LU from the rear side.

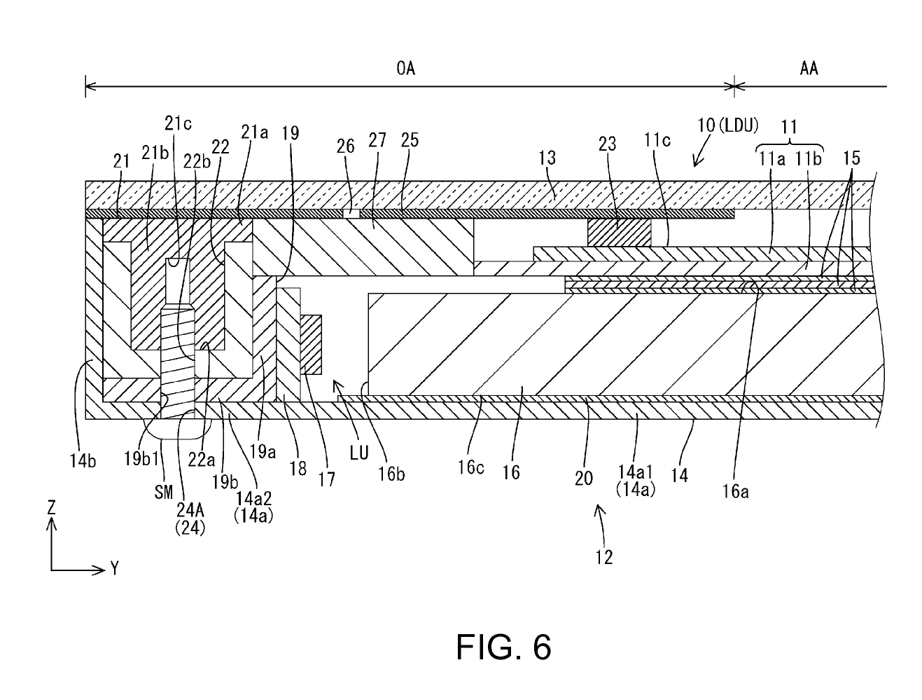

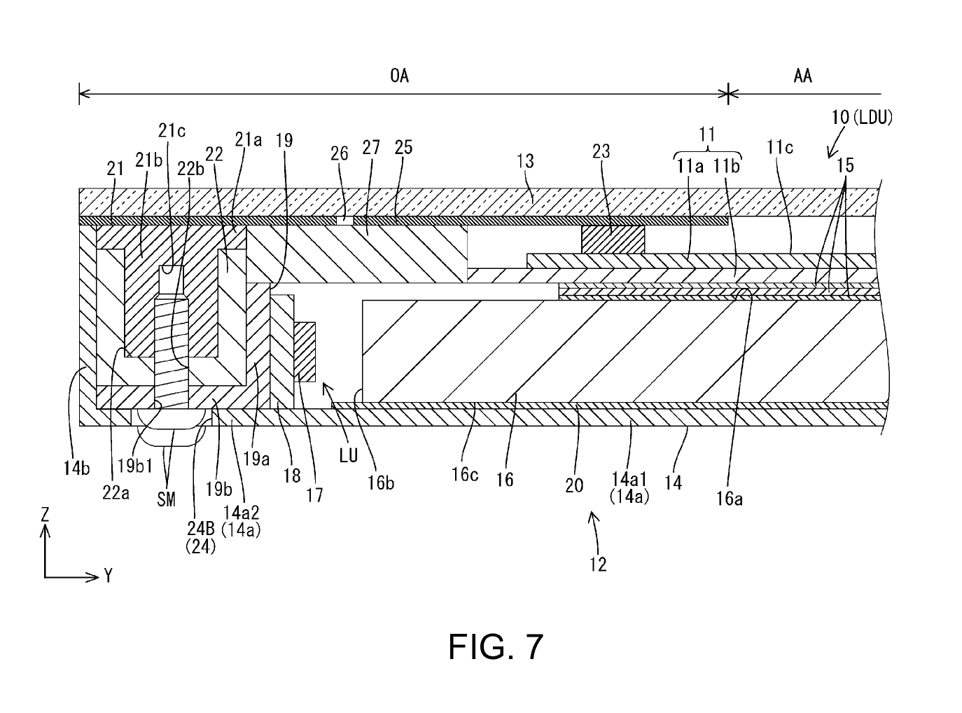

As shown in FIG. 4, each of the heat dissipating sections 19b of the heat dissipating members 19 constituting the LED units LU is attached to the LED unit receiving part 14a2 and make surface-to-surface contact with the front surface thereof. An insertion hole 24 is formed in each of the LED unit receiving parts 14a2, and this insertion hole is where the screw SM for holding the heat dissipating section 19b and LED unit receiving part 14a2 in place with the screw receiving section 21b is held. As shown in FIG. 6, among the insertion holes 24 there is a fastening insertion hole 24A having a size that only allows the shaft of the screw SM to be inserted, and as shown in FIG. 7, there is a heat dissipating member through hole 24B having a size that allows both the shaft and the head of the screw SM to be inserted. The screw SM passing through the former fastens the heat dissipating section 19b and LED unit receiving part 14a2 together to attach these to the screw receiving section 21b, whereas the screw SM inserted through the latter functions to only allow the heat dissipating section 19b to be attached to the screw receiving section 21b. There are a plurality of the insertion holes 24 formed in both shorter side edges of the bottom 14a, and inserting the respective screws SM in these allows the screws SM to be fastened to the respective screw receiving sections 21b through the spacer members 22 on the shorter sides (see FIG. 3).

As shown in FIG. 3, the side walls 14b each rise towards the front side of the liquid crystal display device from the peripheral edges of the bottom 14a. The side walls are a substantially square-tube shape as a whole. The side walls 14b surround the entirety of the liquid crystal panel 11, optical members 15, light guide plate 16, and LED units LU housed therein, and the protruding end faces of the side walls 14b abut or are adjacent to the rear surface of the peripheral edges of the light transmissive panel 13 on the front side. The exterior surfaces of the side walls 14b are exposed to the circumferential exterior of the liquid crystal display device 10 and constitute the top, bottom, and sides of the liquid crystal display device 10.

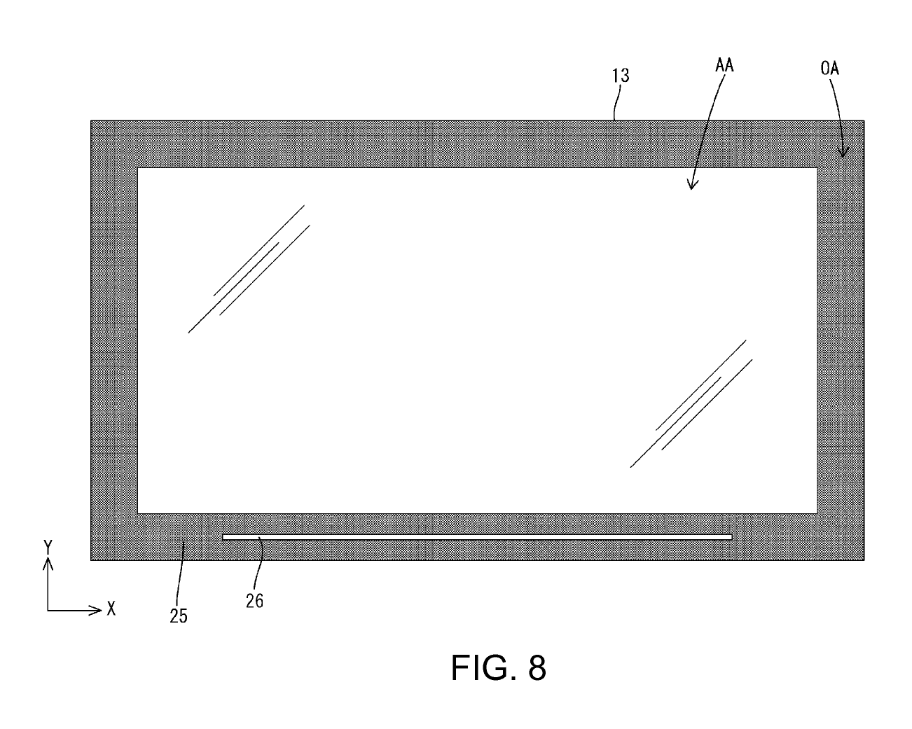

As shown in FIGS. 6 and 8, a light-shielding member 25 that is disposed surrounding the display area AA of the liquid crystal panel 11 and that blocks light around the display area AA is disposed on the light transmissive panel 13 of the present embodiment. In FIG. 8, the area of the light-shielding member 25 on the light transmissive panel 13 is shown by the half-tone dot meshing. The light-shielding member 25 is made of a material with light blocking characteristics such as a black coating, for example, and the light blocking material of the light-shielding member 25 is printed on the rear surface of the light transmissive panel 13, or in other words, on the surface near the liquid crystal panel 11, to integrally form the light-shielding member 25 on this same surface. Accordingly, the light from the LEDs 17 is blocked by the light-shielding member 25 before being radiated onto the rear surface of the light transmissive panel 13 around the display area AA; thus, light can be prevented from entering the light transmissive panel 13 around the display area AA. The light-shielding member 25 formed on the rear surface of the light transmissive panel 13 is not exposed to the outside on the front of the light transmissive panel 13. When the light-shielding member 25 is provided, printing methods such as screen printing, ink-jet printing, or the like can be used, for example.

As shown in FIGS. 6 and 8, the light-shielding member 25 is a horizontally-long quadrangular frame shape, similar to the outer shape of the liquid crystal panel 11 (the display area AA), and the peripheral end position of the light-shielding member 25 approximately corresponds to the peripheral end position of the light transmissive panel 13, whereas the inner peripheral end position of the light-shielding member approximately corresponds to the peripheral end position of the display area AA of the liquid crystal panel 11 in a plan view (viewed from the display surface 11c side). In other words, the external dimensions of the light-shielding member 25 approximately correspond to the external dimensions of the light transmissive panel 13, whereas the inner dimensions approximately correspond to the outer dimensions of the display area AA of the liquid crystal panel 11. In FIG. 8, the white quadrangular area inside the half-tone dot meshing is the display area AA. In this way, the light-shielding member 25 extends over almost the entirety (all areas except for a transparent part 26, which is described later) of an outer area OA around the display area AA of the liquid crystal panel 11 on the light transmissive panel 13. This outer area includes the non-display area of the liquid crystal panel 11 and the peripheral area of the liquid crystal panel 11. Specifically, the light-shielding member 25 overlaps the non-display area, which is the peripheral portion of the liquid crystal panel 11, in a plan view, and is in a positional relationship that additionally overlaps the peripheral portion (the portion arranged around the display area AA) of the optical members 15, the peripheral portion of the light guide plate 16, almost all of the LED units LU, almost all of the space between the light receiving faces 16b of the light guide plate 16 and the LEDs 17, almost all of the screw receiving members 21, almost all of the spacer members 22, and almost all of the cushioning members 23. With this configuration, the light-shielding member 25 can block light that is incident on the edges of the liquid crystal panel 11 near the LEDs 17 and light that could be directly incident on the light transmissive panel 13 from the LEDs 17 from being emitted from the light transmissive panel 13 on the outer area OA around the display area AA of the liquid crystal panel 11, without the light entering the light guide plate 16 from the LEDs 17. This makes it possible to prevent light leakage from the outer area OA around the display area AA.

As shown in FIGS. 6 and 8, the transparent area 26, which allows light to pass therethrough, is formed on a part of the light-shielding member 25. In FIG. 8, the area of the transparent part 26 on the light transmissive panel 13 is shown by the white surrounded by the half-tone dot meshing (light-shielding member 25). After the light-shielding member 25 forming a part of the frame is formed on the light transmissive panel 13, the transparent part 26 is formed by removing a portion of the formed light-shielding member 25 or by forming the light-shielding member 25 such that this portion is not formed during the forming thereof. As shown in FIG. 6, the transparent part 26 is disposed from the light-emitting surface of the LED 17 to the light receiving face 16b of the light guide plate 16 in the Y axis direction (parallel to the LED 17 and light guide plate 16). In other words, the transparent part overlaps the space between the LED 17 and the light receiving face 16b in a plan view. The transparent part 26 is in the area (the placement area of the LED 17) of the LED unit LU in the X axis direction. As shown in FIG. 8, on the frame-shaped light-shielding member 25, the transparent part 26 is formed on one longer side (on the bottom in FIG. 8) of the pair of longer sides respectively overlapping the LED units LU in a plan view, and the arrangement of the transparent part 26 is substantially in the center of the length direction of this longer side. The transparent part 26 is formed to display a prescribed design mark in a plan view (seen from the display surface 11c side), and in FIG. 8 a mark, shown as an example, is formed by a straight line with a prescribed width along the X axis direction (the longer side direction of the light transmissive panel 13 and light-shielding member 25). The above-mentioned design mark is displayed on the light transmissive panel 13 by light from the LEDs 17 passing through the transparent part 26, which is formed on a part of the light-shielding member 25.

As shown in FIG. 6, a light diffusing member 27 that diffuses light from the LEDs 17 is disposed in the liquid crystal display device 10 of the present embodiment between the transparent part 26 and the LEDs 17. The light diffusing member 27 has a large number of diffusing particles dispersed inside an almost transparent base substrate made of a synthetic resin and functions to diffuse light that passes therethrough. The light diffusing member 27 is fixed by a fixing material such as an adhesive in a state abutting the rear surface of the light transmissive panel 13, or in other words, the forming surface of the light-shielding member 25. The light diffusing member 27 has a horizontally-long substantially block shape that extends along the longer side direction of the light-shielding member 25 and faces the transparent part 26 by being attached to the longer side of at least where the transparent part 26 is formed on the light-shielding member 25. The light diffusing member 27 covers the entirety of the transparent part 26 and also covers the peripheries of the light-shielding member 25 around the transparent part 26. Due to this, it is possible to provide light from the LEDs 17, which has been diffused by passing through the light diffusing member 27, to the entirety of the transparent part 26 with no unevenness.

As shown in FIGS. 6 and 8, the light diffusing member 27 has a size that is almost the entire length of the longer side direction of the light-shielding member 25 in the length direction (the X axis direction) of the light diffusing member 27. Meanwhile, the light diffusing member 27 has a size that extends in the width direction (Y axis direction) of the light diffusing member 27 from the inner edge position of the screw receiving member 21 to the end face of the rear array substrate 11b constituting a part of the liquid crystal panel 11 on the LED 17 side. Accordingly, the light diffusing member 27 overlaps in a plan view, in order from the outside thereof in the Y axis direction: the LED attachment section 19a of the heat dissipating member 19; the LED substrate 18; the LEDs 17; the space between the light-emitting surfaces of the LEDs 17 and the light receiving face 16b of the light guide plate 16; and the edge of the light guide plate 16 on the LED 17 side. The light diffusing member 27 has a size extending from the inner surface of the light-shielding member 25 in the thickness direction (the Z axis direction) of the light diffusing member 27 to the end face of the LED attachment section 19a of the heat dissipating member 19. The light diffusing member 27 is in a positional relationship overlapping the rear array substrate 11b forming a part of the liquid crystal panel 11 in the Z axis direction.

Accordingly, the light diffusing member 27 is disposed in a direction along the display surface 11c on the outside of the rear array substrate 11b that forms a part of the liquid crystal panel 11, and the side face of the inside (the liquid crystal panel 11 side/the side opposite to the screw receiving member 21) of the light diffusing member 27 abuts the end face of the array substrate 11b on the LED 17 side. This allows the liquid crystal panel 11 to be positioned in the shorter side direction (Y axis direction) of the light diffusing member 27. In other words, the light diffusing member 27 functions to diffuse light from the LEDs 17 and supply it to the transparent part 26, and also to position the liquid crystal panel 11.

As shown in FIG. 4, with this configuration, the light diffusing member 27 functions to position the liquid crystal panel 11; therefore, of the pair of the longer sides of the light-shielding member 25, the light diffusing member 27 is also attached on the longer side where the transparent part 26 is not formed, and this makes it possible to position the liquid crystal panel 11 in the Y axis direction from both sides.

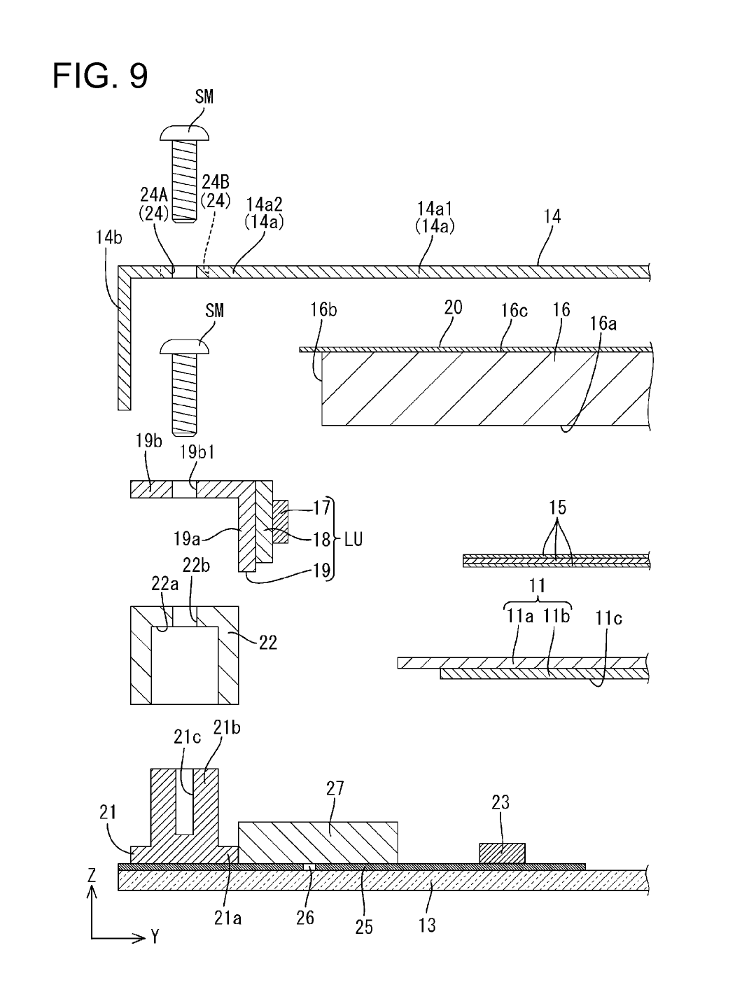

The present embodiment has the above-mentioned structure, and the operation thereof will be explained next. The liquid crystal display device 10 is manufactured by assembling respective constituting components that are manufactured separately (light transmissive panel 13, chassis 14, liquid crystal panel 11, optical members 15, light guide plate 16, LED units LU, and the like) together. In the assembly process, the respective constituting components are assembled after being flipped over with respect to the Z axis direction from the position shown in FIGS. 4 and 6. First, as shown in FIG. 9, the light transmissive panel 13 among the constituting components is set on a work table that is not shown such that the rear surface thereof faces up in the vertical direction. The light-shielding member 25, transparent part 26, light diffusing member 27, screw receiving member 21, and cushioning member 23 are disposed in advance on this light transmissive panel 13.

On the light transmissive panel 13 that has been set with the orientation described above, as shown in FIG. 9, the liquid crystal panel 11 is placed with the CF substrate 11a down and the array substrate 11b up in the vertical direction. At this time, the front surface of the CF substrate 11a of the liquid crystal panel 11 is cushioned by being received by the cushioning member 23 disposed on the light transmissive panel 13. The end face of the array substrate 11b of the liquid crystal panel 11 on the LED 17 side (the longer side) is positioned in the Y axis direction by abutting the inner side face of the light diffusing member 27 disposed on the light transmissive panel 13. Next, the respective optical members 15 are directly stacked on the rear side of the liquid crystal panel 11 in an appropriate order. Thereafter, the light guide plate 16 having the light guide reflective sheet 20 attached thereto is directly stacked on the rear side of the rearmost part of the optical members 15.

Meanwhile, as shown in FIG. 9, the spacer members 22 are respectively attached to the screw receiving members 21 disposed on the light transmissive panel 13. The respective spacer members 22 are attached covering almost the entirety of the frame-shaped base part 21a and each of the screw receiving sections 21b by the respective recessed portion 22a fitting into the protrusion-shaped screw receiving sections 21b. Thereafter, the LED units LU, which are each integrally made of the LEDs 17, LED substrate 18, and heat dissipating member 19, are each attached to the respective spacer members 22 on the longer sides. The LED unit LU is attached to the spacer member 22 in a state in which the LEDs 17 face the center (inside) of the light transmissive panel 13 and the heat dissipating section 19b of the heat dissipating member 19 faces the spacer member 22. In this attachment state, the respective insertion holes 19b1 of the heat dissipating section 19b are matched with the screw holes 21c of the screw receiving section 21b and the insertion hole 22b of the spacer member 22 to form a linked route.

When the LED unit LU is attached to the spacer member 22 in this way, the screw SM will then go through the prescribed insertion hole 19b1 in the heat dissipating section 19b and the insertion hole 22b in the spacer member 22 to screw into the screw hole 21c in the screw receiving section 21b. With this screw SM, the LED unit LU is attached to the screw receiving section 21b and spacer member 22 before the chassis 14 is attached in a manner described below (see FIG. 7). It is preferable that the LED unit LU be attached to the light transmissive panel 13 before the light guide plate 16 is attached, and in such a case, the LED unit LU may be attached before the optical members 15 or the liquid crystal panel 11.

After attaching the liquid crystal panel 11, the optical members 15, the light guide plate 16, and the LED units LU to the light transmissive panel 13 as described above, a process to attach the chassis 14 is conducted. As shown in FIG. 9, the chassis 14 is attached to the light transmissive panel 13 while the front surface of the chassis 14 is facing down in the vertical direction. At this time, the chassis 14 can be positioned with respect to the light transmissive panel 13 by both side walls 14b of the chassis 14 on the longer sides being respectively fitted to the external side faces of the spacer members 22 and both side walls 14b on the shorter sides being fitted to the respective end faces on the shorter sides of the light guide plate 16 (see FIG. 3). In the assembly process, the heads of the screws SM respectively attached in advance to the heat dissipating members 19 and spacer members 22 are passed through each of the heat dissipating member through holes 24B in the LED unit receiving part 14a2 in the bottom 14a of the chassis 14 (see FIG. 7). When the light guide plate receiving part 14a1 of the bottom 14a of the chassis 14 abuts the light guide plate 16 (the light guide reflective sheet 20) and when the respective LED unit receiving parts 14a2 abut the respective heat dissipating sections 19b of the heat dissipating members 19, the screws SM go through each of the fastening insertion holes 24A and screw into the respective screw holes 21c in the screw receiving sections 21b. These screws SM hold the LED units LU and chassis 14 in an attachment state with the respective screw receiving sections 21b of the screw receiving members 21, which are disposed on the light transmissive panel 13 (see FIG. 6). The screws SM go through the respective insertion holes 24 formed in the edges on both shorter sides of the chassis 14, and these screws SM are screwed into the screw hole 21c of the respective screw receiving sections 21b.

The assembly of the liquid crystal display unit LDU is completed in the manner described above. Next, after the stand attachment member STA and various boards PWB, MB, and CTB are attached to the rear side of the liquid crystal display unit LDU, the stand ST and the cover member CV are attached to the rear side, thereby completing the liquid crystal display device 10 and the television receiver TV. The liquid crystal display device 10 manufactured in this manner has the exterior thereof formed of the light transmissive panel 13 that presses the liquid crystal panel 11 from the display surface 11c and chassis 14 forming a part of the backlight device 12. The liquid crystal display device also has the liquid crystal panel 11 and optical members 15 directly stacked together; therefore, by conventionally sandwiching synthetic resin cabinets and the liquid crystal panel 11 from the front and the rear as exterior members, it is possible to reduce the manufacturing cost by reducing the number of components and assembly steps and to make the device thinner and lighter compared to a case in which a configuration having a member that holds the liquid crystal panel 11 and optical members 15 in a non-contact state is used. Furthermore, the manufactured liquid crystal display device 10 has the light transmissive panel 13 made of a single glass board disposed on almost the entire front outer area, and a clear image can be provided to the user (viewer) due to the flat external appearance with no recessions or protrusions when seen from the front. This makes it possible to achieve excellent design characteristics.

As shown in FIG. 4, when the power source of the liquid crystal display device 10 manufactured as described above is turned ON, power is supplied from the power supply board PWB and various signals are supplied to the liquid crystal panel 11 from the control board CTB to control the driving of the liquid crystal panel 11 and to drive the respective LEDs 17 forming the backlight device 12. By passing through the optical members 15 after being guided by the light guide plate 16, light from the respective LEDs 17 is converted to even planar light, which then illuminates the liquid crystal panel 11, and a prescribed image is displayed on the display area AA on the display surface 11c of the liquid crystal panel 11. The light emitted from the liquid crystal panel 11 is viewable by the user (viewer) by passing through the light transmissive panel 13 arranged on the front side of the liquid crystal panel 11. To explain the operation of the backlight device 12 in detail, when the respective LEDs 17 are lit, light emitted from the respective LEDs 17 enters the light receiving faces 16b of the light guide plate 16 as shown in FIG. 6. In the process of travelling through the light guide plate 16 while being subject to the total reflection at the interfaces between the light guide plate 16 and external air spaces, being reflected by the light guide reflective sheet 20, and the like, the light that entered the light receiving faces 16b is reflected or diffused by reflective portions and diffusion portions that are not shown, and thereby outputted from the light exiting surface 16a and being radiated to the optical members 15.

In the liquid crystal display device 10 of the present embodiment, the liquid crystal panel 11 is directly stacked on the light guide plate 16 and the optical members 15, and a panel receiving member is not interposed therebetween unlike the conventional configuration. The liquid crystal panel 11 is pressed by the light transmissive panel 13 arranged on the front side of the liquid crystal panel 11, and the liquid crystal panel 11 is not conventionally pressed by a panel pressing member having light blocking characteristics. Therefore, there is a risk that light emitted from the LEDs 17 will enter the edges of the liquid crystal panel 11 and optical members 15 on the LED 17 side without entering the light guide plate 16, and that light will leak from the outer area (including the non-display area of the liquid crystal panel 11 and the area outside the liquid crystal panel 11) OA of the display area AA in the light transmissive panel 13 by being radiated directly on the light transmissive panel 13. As a countermeasure, in the present embodiment, as shown in FIG. 6, the light-shielding member 25 that blocks light around the display area AA is disposed on the light transmissive panel 13 surrounding the display area AA, thus making it possible to prevent light leakage from the outer area OA around the display area AA on the light transmissive panel 13 and allowing the display quality of images displayed on the display area AA to be enhanced. Furthermore, the transparent part 26 that allows light to pass is formed in a portion of the light-shielding member 25; therefore, a portion of the light blocked by the light-shielding member 25 is emitted by the transparent part 26 from the light transmissive panel 13 at a portion of the outer area OA, thereby making it possible to display a design mark along the planar shape of the transparent part 26 with white light from the LEDs 17, as shown in FIG. 8. In FIG. 8, a straight line design mark is displayed by white light from the LEDs 17 below the display area AA in FIG. 8. This allows a new and non-conventional added value in the form of this design to be provided to the liquid crystal display device 10.

As shown in FIG. 6, the light diffusing member 27 is disposed on the rear surface of the light transmissive panel 13 of the present embodiment, and this light diffusing member 27 is interposed between the LED 17 and the transparent part 26, and thus, light from the LED 17 can be diffused by the light diffusing member 27 and supplied to the transparent part 26, thereby making it harder for uneven brightness to occur in light that passes through the transparent part 26. In particular, this light diffusing member 27 abuts the rear surface of the light transmissive panel 13 and faces the transparent part 26, and is also formed at least from the LED 17 to the light receiving face 16b of the light guide plate 16 in a plan view (seen from the display surface 11c). Therefore, light from the LED 17 can more reliably reach the transparent part 26. In the manner above, a higher display quality of the transparent part 26 can be achieved with even greater design characteristics and the like.

When the respective LEDs 17 are lit in order to use the liquid crystal display device 10, heat is generated from the respective LEDs 17. As shown in FIG. 6, heat generated from the respective LEDs 17 is first transferred to the LED substrate 18, and then transferred to the heat dissipating member 19. The LED attachment section 19a of this heat dissipating member 19 makes surface-to-surface contact with the synthetic resin spacer member 22, and the heat dissipating section 19b makes surface-to-surface contact with the LED unit receiving part 14a2 of the bottom 14a of the metal chassis 14, and efficient heat dissipation is facilitated by more heat being transmitted towards the chassis 14, which has relatively high thermal conductivity. In this manner, heat from the LEDs 17 can be dissipated to the outside using the thermal capacity of the chassis 14, and as a result, heat is less likely to be trapped inside of the liquid crystal display device 10.

The liquid crystal display device (display device) 10 of the present embodiment as described above includes: the LEDs (light sources) 17; the liquid crystal panel (display panel) 11 having the display surface 11c that can display images through light from the LEDs 17, and the display area AA that is where the images on the display surface 11c are displayed; the light guide plate 16 that is disposed so as to overlap the side opposite to the display surface 11c of the liquid crystal panel 11 and that has end faces (light receiving faces 16b) facing the LEDs 17; the chassis 14 disposed on the side of the light guide plate 16 opposite to the liquid crystal panel 11; the light transmissive panel 13 that is arranged so as to overlap the display surface 11c of the liquid crystal panel 11, that houses the LEDs 17 between the light transmissive panel 13 and the chassis 14, and that sandwiches the liquid crystal panel 11 and light guide plate 16 while allowing light to pass through; and the light-shielding member 25 that is disposed on the light transmissive panel 13 surrounding the display area AA of the liquid crystal panel 11 and that blocks light around the display area AA, a part of the light-shielding member 25 being made of the transparent part 26 that allows light to pass through.

In this way, light emitted from the LEDs 17 is guided to the liquid crystal panel 11 after entering the end faces of the liquid guide plate 16 facing the LEDs 17, and by using the light, an image is displayed on the display area AA on the display surface 11c of the liquid crystal panel 11. By overlapping the display surface 11c of the liquid crystal panel 11, the light transmissive panel 13 can enhance the design characteristics of the liquid crystal display device 10 and protect the liquid crystal panel 11, and can allow light emitted from the liquid crystal panel 11 to pass through. Therefore, the display of the liquid crystal panel 11 will not be blocked.

The liquid crystal panel 11 and light guide plate 16 mutually overlap and are sandwiched from the display surface 11c and the opposite side thereof by the light transmissive panel 13 and the chassis 14, and the liquid crystal panel is not sandwiched in the conventional manner by the panel pressing member on the front side and the panel receiving member on the rear side; therefore, there is a risk that light from the LEDs 17 will leak from around the display area AA by passing through the light transmissive panel 13 without going through the light guide plate 16.

As a countermeasure, the light-shielding member 25 that surrounds the display area AA and that blocks light around the display area AA is disposed on the light transmissive panel 13, and thus, light can be prevented from being emitted from the light transmissive panel 13 around the display area AA. Furthermore, the transparent part 26 that allows light to pass is formed in a portion of the light-shielding member 25; therefore, a portion of the light blocked by the light-shielding member 25 is emitted by the transparent part 26 from the light transmissive panel 13 in at least a portion around the display area AA, thereby making it possible to display a prescribed trademark (letter, figure, symbol, etc.), design mark, or the like, for example, corresponding to the shape of the transparent part 26. This allows a new and non-conventional added value in the form of this design to be provided to the liquid crystal display device 10.

The light diffusing member 27 that diffuses light from the LED 17 is disposed between the transparent part 26 and the LED 17. In this way, the light diffusing member 27 between the transparent part 26 and LED 17 diffuses light from the LED 17, thereby providing light to the transparent part 26 from the light diffusing member 27 and making it harder for uneven brightness to occur with light that passes through the transparent part 26. In the manner above, a higher display quality of the transparent part 26 can be achieved with even greater design characteristics and the like.

The light diffusing member 27 is arranged on the outside of the liquid crystal panel 11 and abuts the end face of the liquid crystal panel 11. In this way, the liquid crystal panel 11 can be positioned due to the light diffusing member 27 arranged on the outside of the liquid crystal panel 11 abutting the end face of the liquid crystal panel 11, which is excellent for assembly workability and the like during manufacturing. Due to the light diffusing member 27 for diffusing light from the LED 17 also having this positioning function for the liquid crystal panel 11, the number of components can be reduced and the like compared to a case in which a separate positioning member is provided in addition to the light diffusing member 27.

The light diffusing member 27 abuts the light transmissive panel 13 on the liquid crystal panel 11 side while facing the transparent part 26. In this way, the light that is diffused and emitted by the light diffusing member 27 can more reliably reach the transparent part 26.

The light diffusing member 27 is integrally fixed to the light transmissive panel 13. As such, it is harder for a gap to form between the light transmissive panel 13 and the light diffusing member 27 due to the light diffusing member 27 being fixed to the light transmissive panel 13; therefore, the light emitted by the light diffusing member 27 can even more reliably enter the transparent part 26. This is excellent for assembly workability during manufacturing of the liquid crystal display device 10.

The light diffusing member 27 is formed at least from the LED 17 to the end face of the light guide plate 16 seen from the display surface 11c side. As such, there is a large amount of light from the LED 17 between the LED 17 and the end face of the light guide plate 16, and thus, the light can more reliably enter the transparent part 26 by being diffused by the light diffusing member 27.

The light-shielding member 25 is disposed on the surface of light transmissive panel 13 on the liquid crystal panel 11 side. In this way, light from the LED 17 can be blocked by the light-shielding member 25, except at the transparent part 26, before being radiated onto the light transmissive panel 13 around the display area AA; therefore, even if light were to be radiated onto the light transmissive panel 13, problems such as this leaking from the end face of the light transmissive panel 13 and the like can be prevented. The light-shielding member 25 can avoid being exposed to outside of the light transmissive panel 13, and therefore, the light-shielding member 25 is not susceptible to being damaged or the like, and this is suitable for ensuring the light blocking function.

The liquid crystal display device also includes: the screw receiving member 21 that is disposed on the surface of the light transmissive panel 13 on the liquid crystal panel 11 side and that has the screw receiving section 21b protruding towards the chassis 14; and the screw SM that penetrates the chassis 14 while sandwiching the chassis 14 between the screw receiving section 21b and the screw SM by being fastened to the screw receiving section 21b. In this way, when the screw SM is fastened to the screw part of the screw receiving member 21, the chassis 14 holds the liquid crystal panel 11 and light guide plate 16 in a sandwiched state with the light transmissive panel 13 where the screw receiving member 21 is disposed. As such, the light transmissive panel 13 can have a holding function with the chassis 14.

The liquid crystal display device further includes the heat dissipating member (light source attachment member) 19 having the LED attachment section 19a arranged on the side of the LED 17 opposite to the light guide plate 16 and where the LED 17 is attached, and the heat dissipating section 19b that faces the screw receiving section 21b and that makes surface-to-surface contact with the chassis 14. The screw SM sandwiches the chassis 14 and the heat dissipating section 19b between the screw and the screw receiving section 21b. In this way, the heat dissipating section 19b can be sandwiched together with the chassis 14 between the screw SM and the screw receiving section 21b; therefore, the positional relationship between the LED 17 attached to the heat dissipating member 19 having the heat dissipating section 19b and the light guide plate 16 held by the light transmissive panel 13 and the chassis 14 can be maintained with stability, and efficiency by which the light enters the light guide plate 16 from the LEDs 17 can be made stable. The heat generated by the LED 17 can be efficiently transmitted from the heat dissipating section 19b towards the chassis 14, which allows the heat dissipating characteristics to be improved.

Embodiment 1 of the present invention has been described above, but the present invention is not limited to the embodiment above, and may include modification examples below, for example. In the modification examples below, components similar to those in the embodiment above are given the same reference characters, and descriptions and depictions thereof may be omitted.

### Modification Example 1 of Embodiment 1

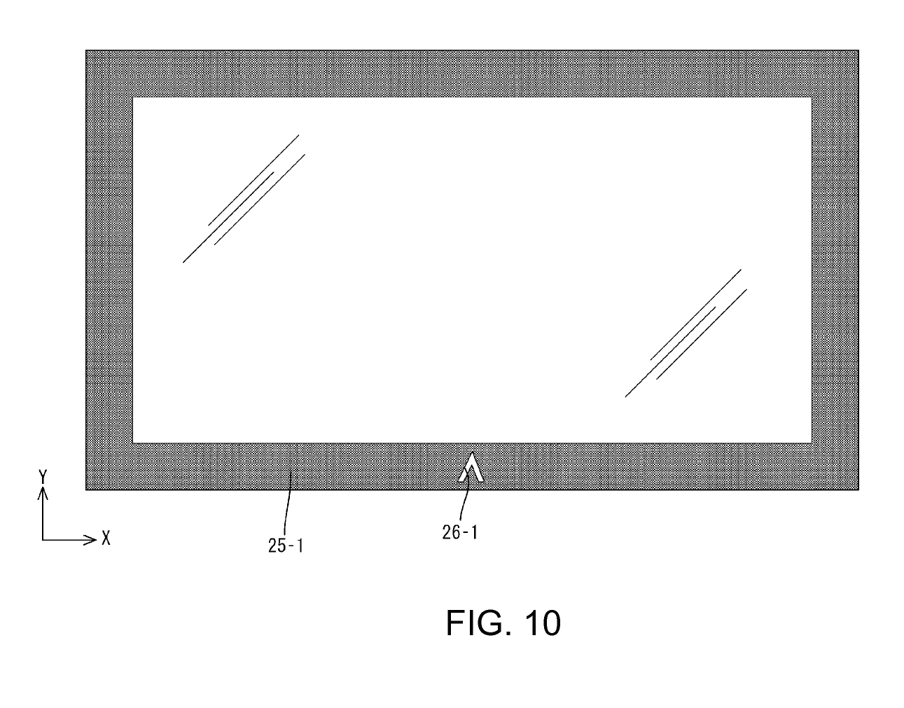

Modification Example 1 of Embodiment 1 will be described with reference to FIG. 10.

FIG. 10 shows a configuration where a plane shape (design shape) of a transparent part 26-1 has been changed.

As shown in FIG. 10, the transparent part 26-1 according to the present modification example is a shape exhibiting a design mark with a substantially reversed “V” shape in a plan view. The transparent part 26-1 is arranged in approximately the center of a longer side direction (the X axis direction) of a light-shielding member 25-1. Although not shown in FIG. 10, the area of the light diffusing member 27 in the X axis direction can have a size that is approximately wider than the area of the transparent part 26-1.

### Modification Example 2 of Embodiment 1

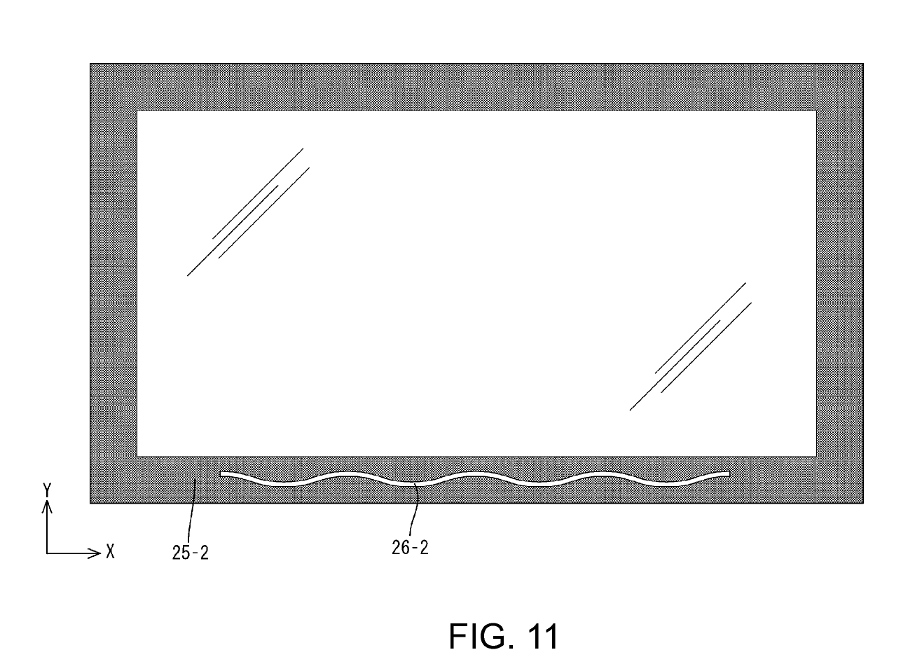

Modification Example 2 of Embodiment 1 will be described with reference to FIG. 11.

FIG. 11 shows a configuration where a plane shape (design shape) of a transparent part 26-2 has been changed.

As shown in FIG. 11, the transparent part 26-2 according to the present modification example is a shape exhibiting a design mark with a wave shape extending along the longer side direction of the light-shielding member 25-2 in a plan view.

### Modification Example 3 of Embodiment 1

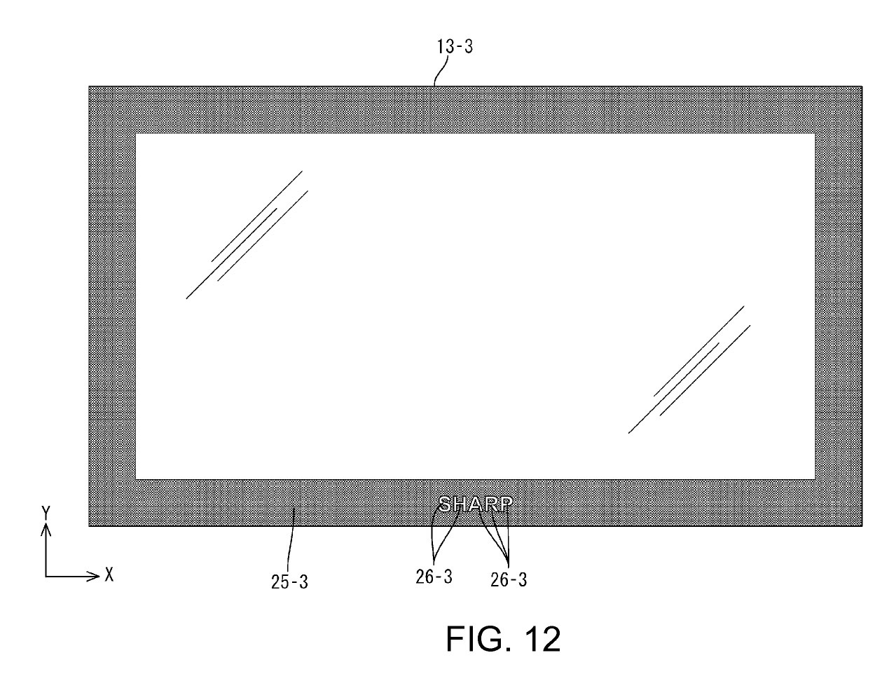

Modification Example 3 of Embodiment 1 will be described with reference to FIG. 12.

FIG. 12 shows a configuration where the plane shape of a transparent part 26-3 has been changed to a name of a company.

As shown in FIG. 12, the transparent part 26-3 of the present modification example is a shape exhibiting a name of a company manufacturing the liquid crystal display device 10 in a plan view. In FIG. 12, the transparent parts 26-3 exhibit a name of a specific company by arranging a plurality of prescribed alphabetical characters in parallel along the longer side direction of a light-shielding member 25-3. The transparent part 26-3 displays the characters constituting the above-mentioned name of a company on the light transmissive panel 13-3 by allowing light from the LEDs 17 to pass through.

### Modification Example 4 of Embodiment 1

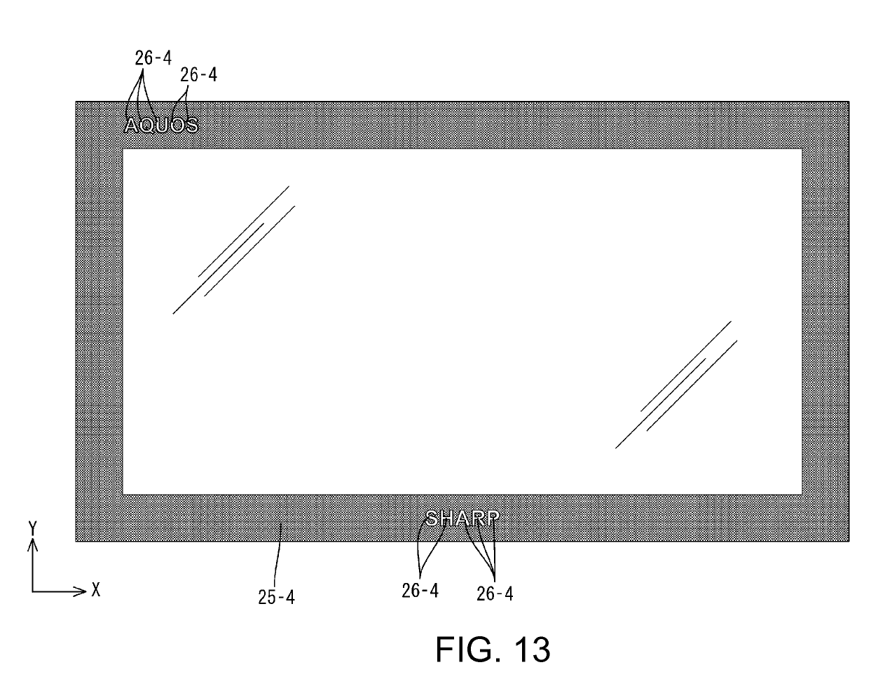

Modification Example 4 of Embodiment 1 will be described with reference to FIG. 13. FIG. 13 shows a configuration in which transparent parts 26-4 are disposed on each of the pair of longer sides of a light-shielding member 25-4.

As shown in FIG. 13, the transparent parts 26-4 according to the present modification example are respectively disposed on each of the pair of longer sides of the light-shielding member 25-4. Of the pair of longer sides of the light-shielding member 25-4, the transparent parts 26-4 exhibiting the same name of the company as in the configuration as described in Modification Example 3 above, are formed in the bottom longer side shown in FIG. 13, whereas the transparent parts 26-4 exhibiting a brand name (trademark) of the liquid crystal display device 10 are formed in the top longer side shown in FIG. 13. The transparent parts 26-4 displaying this brand name are disposed near one end of the light-shielding member 25-4 in the longer side direction (X axis direction) thereof. In FIG. 13, the respective transparent parts 26-4 respectively display a specific name of a company and brand name by a plurality of prescribed alphabetical characters being arranged in parallel along the longer side direction of the light-shielding member 25-4. Although not shown, light from the LEDs 17 of the pair of LED units LU respectively disposed on the longer side edges of the liquid crystal display device 10 is provided to the transparent parts 26-4 displaying the name of the company and the transparent parts 26-4 displaying the brand name after this light has been diffused by the light diffusing member 27. In this way, a clear display with no uneven brightness will be displayed by the respective transparent parts 26-4.

### Embodiment 2

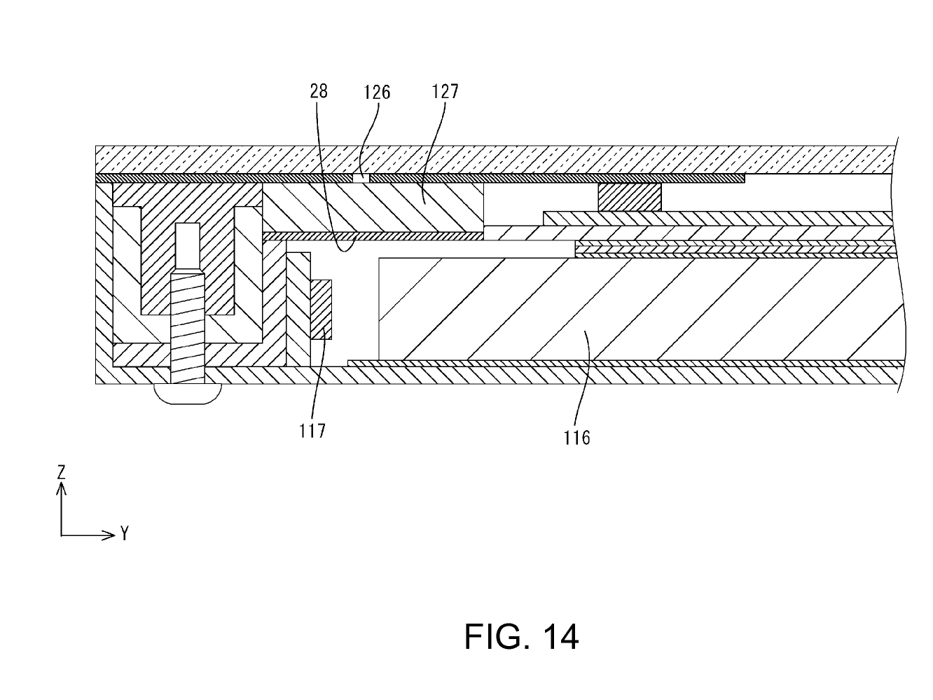

Embodiment 2 of the present invention will be described with reference to FIG. 14. In Embodiment 2, a wavelength-selective light transmissive sheet 28 is attached to a light diffusing member 127. Descriptions of structures, operations, and effects similar to those of Embodiment 1 will be omitted.

As shown in FIG. 14, the light diffusing member 127 of the present embodiment has the wavelength-selective light transmissive sheet (wavelength-selective light transmissive member) 28 attached thereto. The wavelength-selective light transmissive sheet 28 covers almost the entirety of the rear surface of the light diffusing member 127, or in other words, the surface facing an LED 117 and light guide plate 116. The wavelength-selective light transmissive sheet 28 can selectively allow specific wavelengths of visible light to pass therethrough. If the wavelength-selective light transmissive sheet 28 is configured to selectively allow wavelengths in the blue range (420 nm to 500 nm) to pass through, for example, then the visible light that passes through the wavelength-selective light transmissive sheet 28 and enters the light diffusing member 127 will be a blue light exhibiting a blue color; thus, blue light can be provided to a transparent part 126 after being diffused by the diffusing member 127. In addition to blue, the wavelength-selective light transmissive sheet 28 can also be configured to selectively allow wavelengths in the green range (500 nm to 570 nm), red range (600 nm to 780 nm), and yellow range (570 nm to 600 nm) to pass through, and green light, red light, and yellow light can be supplied to the transparent part 126. By using a specific color other than white for the light supplied to the transparent part 126 by the wavelength-selective light transmissive sheet 28 in this manner, the presentation and design characteristics of the display of the transparent part 126 can be further enhanced.

According to the present embodiment as described above, the wavelength-selective light transmissive sheet (wavelength-selective light transmissive member) 28, which selectively allows a specific wavelength of visible light to pass therethrough, is attached to the light diffusing member 127. In this manner, light of a specific wavelength that has selectively passed through the wavelength-selective light transmissive sheet 28 can be supplied to the transparent part 126; therefore, the presentation and design characteristics of the display of the transparent part 126 can be further enhanced.

### Embodiment 3

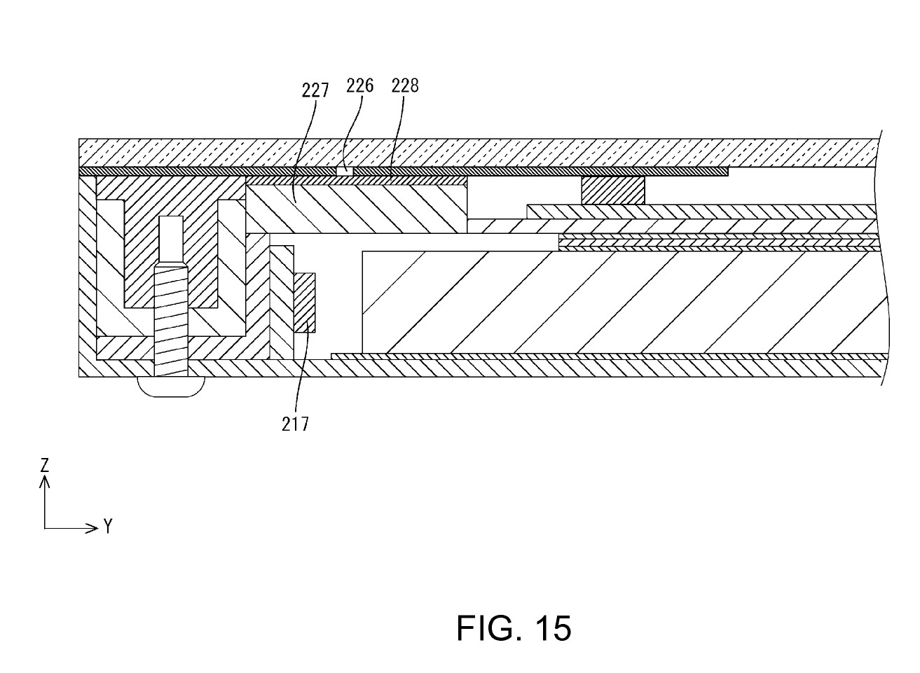

Embodiment 3 of the present invention will be described with reference to FIG. 15. Embodiment 3 could be considered a modification example of Embodiment 2 described above.

FIG. 15 shows a configuration in which an arrangement of a wavelength-selective light transmissive sheet 228 has been modified. Descriptions of structures, operations, and effects similar to those of Embodiment 2 will be omitted.

As shown in FIG. 15, the wavelength-selective light transmissive sheet 228 of the present embodiment covers almost the entirety of the front surface of a light diffusing member 227, or in other words, the surface facing a light transmissive panel 213 and transparent part 226. With such a configuration, after light from an LED 217 enters and is diffused by the light diffusing member 227, only light that is in a specific wavelength will be selectively supplied to the transparent part 226 by passing through the wavelength-selective light transmissive sheet 228. In this way, effects and results similar to Embodiment 2 described above can be achieved.

### Embodiment 4

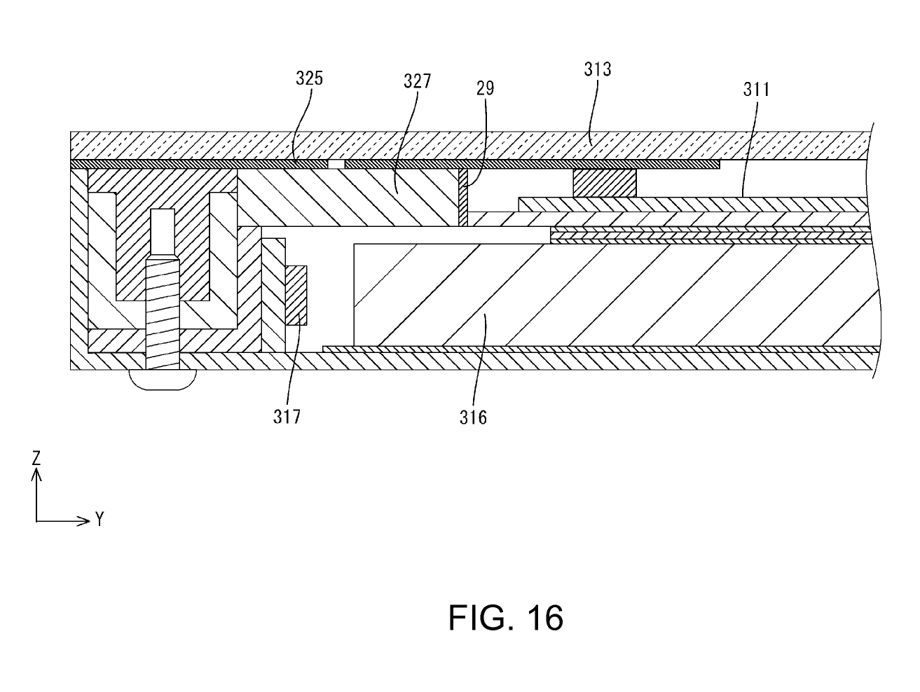

Embodiment 4 of the present invention will be described with reference to FIG. 16. In Embodiment 4, FIG. 16 shows a configuration where a light-shielding member 29 has been interposed between a light diffusing member 327 and an end face of a liquid crystal panel 311. Descriptions of structures, operations, and effects similar to those of Embodiment 1 will be omitted.

As shown in FIG. 16, the light-shielding member 29 that blocks light is attached to an inner side face of the light diffusing member 327 of the present embodiment. This light-shielding member 29 is interposed between the light diffusing member 327 and an end face of the liquid crystal panel 311 near an LED 317. The light-shielding member 29 is made of a light blocking material such as a coating exhibiting a black color, in a manner similar to the light-shielding member 325 of the light transmissive panel 313. Coating this light blocking material onto the side face of the light diffusing member 327 integrally forms the light-shielding member on the light diffusing member 327. The light-shielding member 29 can prevent light diffused by the light diffusing member 327 from being emitted farther inside than the light diffusing member 327, or in other words, towards the liquid crystal panel 311; therefore, light from the LED 317 can be prevented from being directly incident on the liquid crystal panel 311 without going through a light guide plate 316. A reflective sheet that has light reflective characteristics due the surface thereof being white can also be used as the light-shielding member 29.

### Embodiment 5

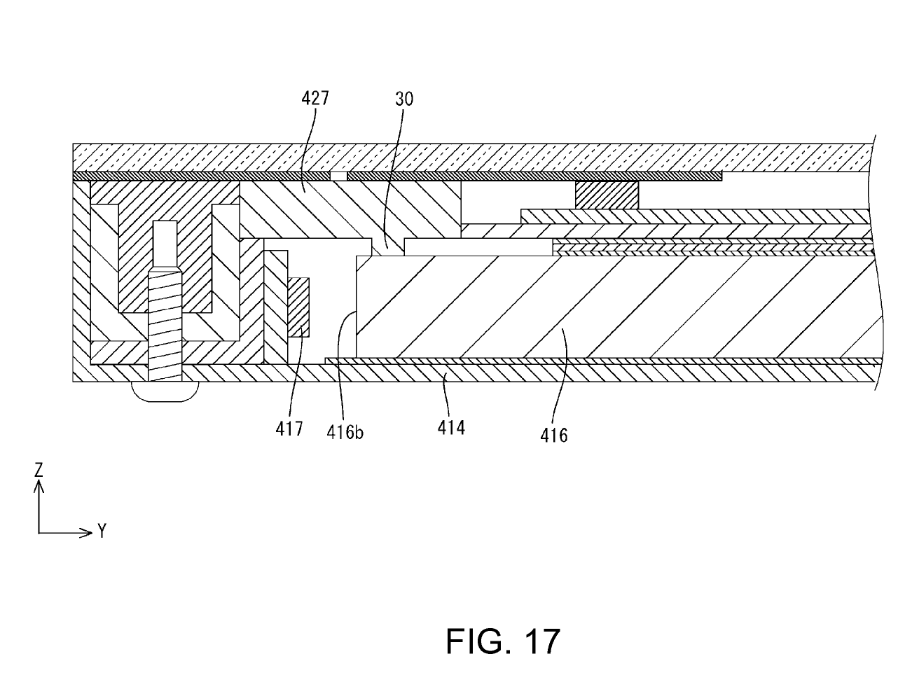

Embodiment 5 of the present invention will be described with reference to FIG. 17. In Embodiment 5, FIG. 17 shows a configuration in which a light guide plate support portion 30 that supports a light guide plate 416 has been disposed on a light diffusing member 427. Descriptions of structures, operations, and effects similar to those of Embodiment 1 will be omitted.

As shown in FIG. 17, the light guide plate support member 30 capable of supporting the light guide plate 416 is disposed on the light diffusing member 427 of the present embodiment by abutting the light guide plate 416. The light guide plate support portion 30 has a protrusion that protrudes from the rear surface of the light diffusing member 427, or in other words, the surface of the light guide plate 416 facing the light diffusing member 427, towards the rear side along the Z axis direction. The tip surface of the protrusion abuts the light guide plate 416. The end of the light guide plate support portion 30 can be positioned together with a chassis 414 along the Z axis direction by abutting an end of the light guide plate 416 on an LED 417 side. In this way, the positional relationship between a light receiving face 416b of the light guide plate 416 and the LED 417 can be maintained with stability, and the incidence efficiency of light entering the light receiving face 416b can be stabilized.

### Other Embodiments

The present invention is not limited to the embodiments shown in the drawings and described above, and the following embodiments are also included in the technical scope of the present invention, for example.

(1) In the respective embodiments above, the transparent part displaying a design mark, name of a company, or brand name (trademark) was shown as an example, but the present invention also includes a configuration in which the transparent part is used as a power supply lamp for letting the user know if the power is ON or OFF.

(2) In the respective embodiments above, the transparent part extending from the light-emitting surface of the LED to the light receiving face of the light guide plate was shown as an example, but the present invention also includes the transparent part protruding outside this range. Specifically, a portion of the transparent part can be positioned so as to overlap at least one of the LED, LED substrate, heat dissipating member, or light guide plate in a plan view.

(3) The entirety of the transparent part may be disposed outside the above-mentioned range without being disposed from the light-emitting surface of the LED to the light receiving face of the light guide plate, in a manner opposite to (2).

(4) In the respective embodiments above, the light diffusing member being attached to the light transmissive panel was shown as an example, but the light diffusing member may be attached to the screw receiving member, heat dissipating member, or the like.

(5) With respect to (4) above, the light diffusing member can be separated (in a non-contact state) from the light transmissive panel, thereby securing a gap between the light diffusing member and the light transmissive panel.

(6) In the respective embodiments above, the light diffusing member being formed from the inner face of the screw receiving member to the end face of the array substrate of the liquid crystal panel was shown as an example, but the area of the light diffusing member can be modified as appropriate. In such a case, it is preferable that the light diffusing member be formed from the light-emitting surface of the LED to the light receiving face of the light guide plate in order to sufficiently function to supply light from the LED to the transparent part.

(7) The entirety of the light diffusing member may be disposed outside the above-mentioned range without being disposed from the light-emitting surface of the LED to the light receiving face of the light guide plate, in a manner opposite to (6).

(8) In the respective embodiments above, the light-shielding member being formed on the rear surface of the light transmissive panel was shown as an example, but the present invention also includes the light-shielding member being formed on the front surface of the light transmissive panel.

(9) In the respective embodiments above, a tempered glass that has undergone a chemically strengthened treatment being used as the light transmissive panel was shown as an example, but a tempered glass that has undergone an air cooling strengthening treatment can also be used.

(10) In the respective embodiments above, a tempered glass being used as the light transmissive panel was shown as an example, but an ordinary glass material (non-tempered glass) can also be used.

(11) In addition to Embodiment 1 and Modification Examples 1 and 2 above, the specific shape of the design mark displayed by the transparent part may be modified as appropriate.

(12) In addition to Modification Examples 2 and 3 of Embodiment 1 above, the specific characters of the name of the company or brand name (trademark) displayed by the transparent part may be modified as appropriate. The present invention also includes Japanese characters (kanji, hiragana, katakana) or characters from languages other than English and Japanese being used for such characters, for example. A transparent part that displays a specific name of a company or brand name (trademark) by combining symbols and figures with the characters may be provided.

(13) In Embodiments 2 and 3 above, the use of a wavelength-selective light transmissive sheet that respectively selectively allows blue light, red light, green light, and yellow light to pass was shown as an example, but it is also possible to use a wavelength-selective light transmissive sheet that selectively allows light in wavelengths other than the colors above (purple, blue-violet, yellow-green, orange, and the like) to pass through.

(14) In the respective embodiments above, the LED units (heat dissipating members, LED substrates) being disposed as a pair so as to respectively face the ends of the longer sides of the light guide plate was shown as an example, but the present invention also includes the LED units being disposed as a pair so as to respectively face the ends of both shorter sides of the light guide plate, for example.

(15) In addition to (14) above, the present invention also includes a pair each or four in total of the LED units (heat dissipating members, LED substrates) being disposed so as to respectively face the respective ends of both longer sides and shorter sides of the light guide plate, or one LED unit being disposed so as to only face an end of one longer side or one shorter side of the light guide plate. The present invention also includes a configuration in which three LED units are disposed at three side edges of the light guide plate so as to face each other.

(16) In the respective embodiments above, one LED unit (heat dissipating members, LED substrates) was provided at one side of the light guide plate, but it is also possible to provide a plurality of (two or more) LED units at one side of the light guide plate. In such a case, it is preferable that the plurality of LED units be arranged along the side of the light guide plate.

(17) In the respective embodiments above, the light transmissive panel and chassis being the exterior members forming the exterior of the liquid crystal display device was shown as an example, but the present invention also includes the chassis not being exposed to the outside by covering the rear surface thereof with a separately provided external member, for example. In addition to this, the present invention also includes the light transmissive panel and chassis not being exposed to the outside by the light transmissive panel and chassis being covered together by a separately provided external member.

(18) In the respective embodiments above, the chassis constituting an exterior member is made of metal, but the present invention also includes a chassis being made of a synthetic resin. It is preferable to employ this configuration in a mid- to small-sized model that does not require the liquid crystal display device to have very high mechanical strength.

(19) In the respective embodiments above, the chassis and the heat dissipating member were jointly fastened to the screw receiving section by the screw, but the present invention also includes a configuration in which a screw for affixing the chassis to the screw receiving section, and a screw for affixing the heat dissipating member to the screw receiving section are separately provided.

(20) In the respective embodiments above, a screw being used for fixing the chassis and heat dissipating members to the screw receiving section was shown as an example, but a clip made of a synthetic resin may be used to fix the chassis and heat dissipating members by engaging the screw receiving section.

(21) In the respective embodiments above, the power board was provided with the function of powering the LEDs, but the present invention also includes a configuration in which an LED driver board that powers the LEDs is separated from the power board.

(22) In the respective embodiments above, the main board was provided with a tuner part, but the present invention also includes a configuration in which a tuner board that has a tuner part is separated from the main board.

(23) In the respective embodiments above, the colored portions of the color filters provided in the liquid crystal panel included the three colors of R, G, and B, but it is possible to have the colored portions include four or more colors.

(24) In the respective embodiments above, LEDs were used as the light source, but other types of light source such as an organic EL may also be used.

(25) In the embodiments above, TFTs are used as the switching element in the liquid crystal display device, but the present invention can be applied to a liquid crystal display device that uses a switching element other than a TFT (a thin film diode (TFD), for example), and, besides a color liquid crystal display device, the present invention can also be applied to a black and white liquid crystal display device.

(26) In the respective embodiments above, a liquid crystal display device using a liquid crystal panel as a display panel was described as an example, but the present invention can be applied to a display device that uses another type of display panel.

(27) In the respective embodiments above, a television receiver that includes a tuner part was illustratively shown, but the present invention is also applicable to a display device without a tuner.

### DESCRIPTION OF REFERENCE CHARACTERS

10 liquid crystal display device (display device)
11, 311 liquid crystal panel (display panel)
11c display surface
13, 313 light transmissive panel
14, 414 chassis
16, 116, 316, 416 light guide plate
16b, 416b light receiving face (side face)
17, 117, 217, 317, 417 LED (light source)
19 heat dissipating member (light source attachment member)
19a LED attachment section (light source attachment section)
19b heat dissipating section
21 screw receiving member
21b screw receiving section
25, 325 light-shielding member
26, 126, 226 transparent part
27, 127, 227, 327, 427 light diffusing member
28, 228 wavelength-selective light transmissive sheet (wavelength-selective light transmissive member)
AA display area
SM screw
TV television receiver

1. A display device, comprising:
a light source;
a display panel having a display surface and a display area within the display surface, the display area being where the image is displayed using light from the light source;
a light guide plate that is disposed so as to overlap a side of the display panel opposite to the display surface and that has an end face opposing the light source;
a chassis disposed on a side of the light guide plate opposite to the display panel;
a light transmissive panel that is disposed so as to cover the display panel on the side of the display surface and that allows light to pass through, the light transmissive panel and the chassis sandwiching the display panel and the light guide plate while housing the light source therebetween; and
a light-shielding member provided to the light transmissive panel, the light-shielding member being arranged so as to surround the display area of the display panel to block light around said display area, a part of the light-shielding member being made of a transparent part that allows light to pass therethrough.

2. The display device according to claim 1, wherein a light diffusing member that diffuses light from the light source is interposed between the transparent part and the light source.

3. The display device according to claim 2, wherein the light diffusing member is disposed on the outside of the display panel and abuts an end face of the display panel.

4. The display device according to claim 2, wherein the light diffusing member faces the transparent part and abuts a surface of the light transmissive panel on the display panel side.

5. The display device according to claim 4, wherein the light diffusing member is integrally fixed to the light transmissive panel.

6. The display device according to claim 2, wherein the light diffusing member is formed at least from the light source to an end face of the light guide plate, as seen from the display surface side.

7. The display device according to claim 2, wherein a wavelength-selective light transmissive member that selectively allows a certain wavelength of visible light to pass through is attached to the light diffusing member.

8. The display device according to claim 1, wherein the light-shielding member is disposed on a surface of the light transmissive panel on the display panel side.

9. The display device according to claim 1, further comprising:
a screw receiving member that is disposed on a surface of the light transmissive panel on the display panel side and that has a screw receiving section protruding towards the chassis; and
a screw that sandwiches the chassis between the screw and the screw receiving section by being fastened to the screw receiving section while penetrating the chassis.

10. The display device according to claim 9, further comprising:
a light source attachment member that has a light source attachment section that is disposed on a side of the light source opposite to the light guide plate and that is where the light source is attached, and a heat dissipating section that faces the screw receiving section and that makes surface-to-surface contact with the chassis,
wherein the screw sandwiches the chassis and the heat dissipating section between the screw and the screw receiving section.

11. The display device according to claim 1, wherein the display panel is a liquid crystal panel made of liquid crystal sealed between a pair of substrates.

12. A television receiver, comprising the display device according to claim 1.
